(19) United States
(12) Patent Application Publication
(10) Pub. No.: US 2026/0330223 A1
(43) Pub. Date: Oct. 22, 2026

(54) SYSTEM

(71) Applicant: SoftBank Group Corp., Tokyo (JP)

(72) Inventor: Norihiko TAKEI, Tokyo (JP)

(73) Assignee: SoftBank Group Corp., Tokyo (JP)

(21) Appl. No.: 19/648,582

(22) Filed: Apr. 15, 2026

(30) Foreign Application Priority Data
Apr. 22, 2025 (JP) 2025-070262

(51) Int. Cl. G06N 3/08; G06N 3/0475; G06N 5/022

(52) U.S. Cl. CPC G06N 3/08; G06N 3/0475; G06N 5/022

(57) ABSTRACT

The present invention relates to a nationwide distributed disaster response social infrastructure that collects and integrates, in real time, various data such as person movement, transportation infrastructure, evacuation shelters, relief supply inventory, and disaster occurrence held by local governments and related organizations nationwide, constructs a digital twin that reproduces the real world in a virtual space with high accuracy, uses generative AI as an essential component to predict and simulate, with high accuracy, a transition of the number of evacuees for each evacuation shelter, a required amount of relief supplies, an operation status of transportation infrastructure, and an optimal relief supply delivery plan when a disaster occurs, visualizes and shares information, and evolves a model by federated learning, thereby realizing prompt and accurate support for disaster victims without depending on conventional manual work and personal judgments.

### CROSS-REFERENCE TO RELATED APPLICATION

The present application claims priority to and incorporates by reference the entire contents of Japanese Patent Application No. 2025-070262 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a complex problem faced by local governments and related organizations nationwide, such as the inability to comprehensively grasp information such as person movement, transportation infrastructure, evacuation shelter capacity statuses, and relief supply inventory and demand in real time when a disaster occurs, information transmission by manual work such as telephone and facsimile, delays in information sharing among organizations, mismatches in relief supply needs, opacity of inventory statuses, difficulty in immediately formulating an optimal relief supply delivery plan, disparities in response capabilities among local governments, difficulty in flexibly responding to unprecedented disasters and new patterns, delays in initial disaster response, and difficulty in realizing prompt and accurate support for disaster victims, and the point is to solve these problems by combining a distributed digital twin, generative AI, and federated learning to realize real-time information collection, integration, analysis, prediction, visualization, and optimization on a nationwide scale, automatically and optimally deliver necessary relief supplies and support to a disaster-stricken area immediately after the occurrence of a disaster without depending on conventional manual work and personal judgments, dramatically improve the disaster response capabilities of local governments and related organizations, and construct a social infrastructure for protecting the lives and living environments of disaster victims.

### SUMMARY OF THE INVENTION

As a means for solving the problem, a configuration is adopted in which a data collection and integration unit configured to collect and integrate, in real time, various data such as person movement data, transportation infrastructure operation status data, evacuation shelter capacity data, relief supply inventory data, and disaster occurrence information data held by local governments and related organizations nationwide is provided, a digital twin generation and update unit configured to reproduce states of real-world cities and regions in a virtual space with high accuracy on a nationwide and regional basis using the data obtained from the data collection and integration unit is provided, a disaster response prediction and simulation unit configured to immediately reflect a disaster event in a model in the virtual space constructed by the digital twin generation and update unit when a disaster occurs, predict and simulate, with high accuracy, a transition of the number of evacuees for each evacuation shelter, a required amount of relief supplies, an operation status of transportation infrastructure, a relief supply delivery plan, and the like from past disaster data and real-time data using generative AI, and automatically generate an optimal relief supply delivery plan is provided, the disaster response prediction and simulation unit operates with the generative AI as an essential component, continuously learns distributed data nationwide using federated learning, and is capable of flexibly responding to unknown disaster patterns and region-specific issues, and an information sharing and visualization unit configured to share and visualize, in real time, information such as relief supply needs, inventory statuses, delivery plans, and transportation progress for each evacuation shelter among local governments, the national government, and related organizations is further provided, thereby realizing prompt and accurate support for disaster victims.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

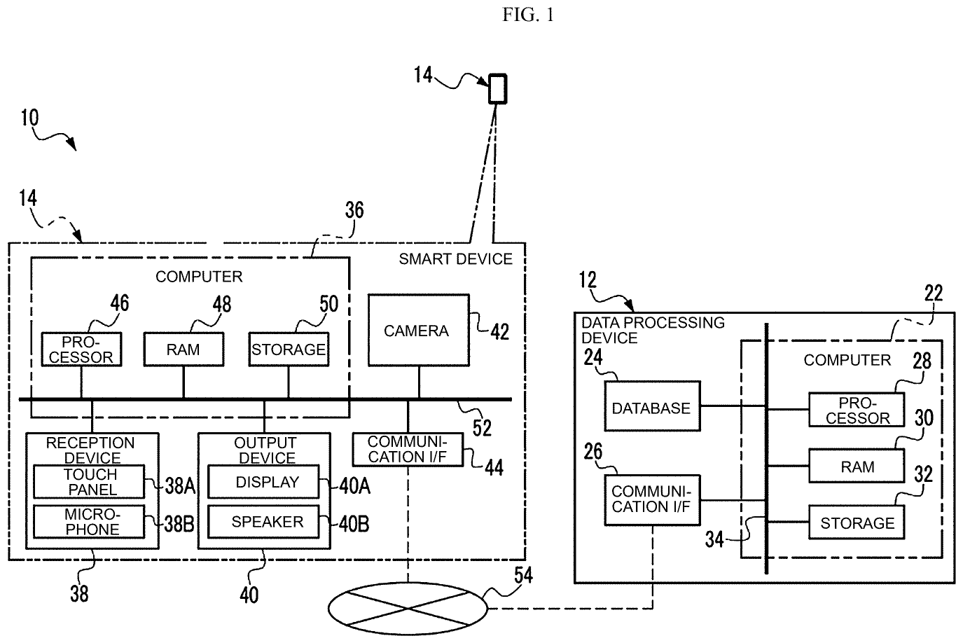

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

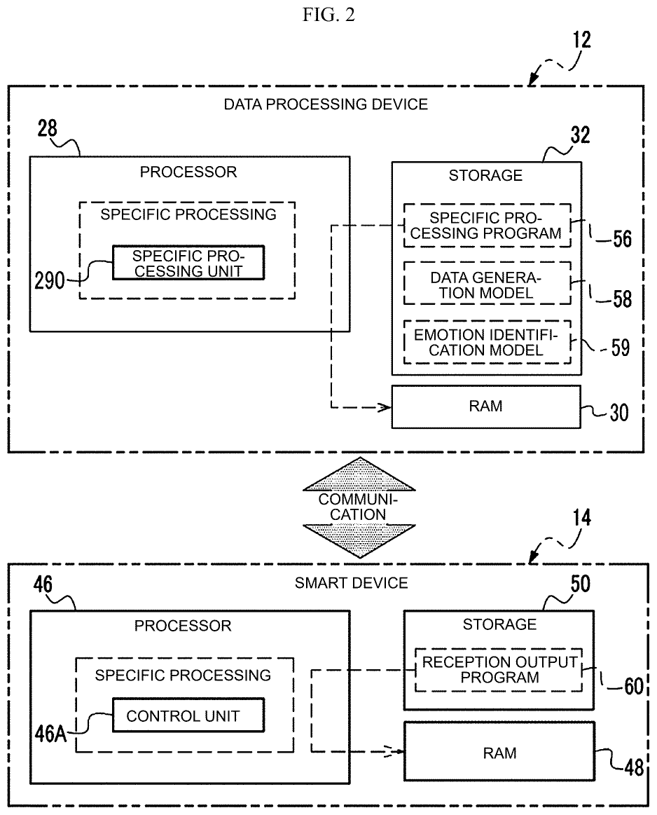

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a system is configured that collects and integrates, in real time, various information held by local governments, related organizations, infrastructure operators, logistics operators, evacuation shelter operators, and the like nationwide, constructs a nationwide distributed digital twin that reproduces the real world in a virtual space with high accuracy, uses generative AI as an essential component when a disaster occurs, predicts and simulates, with high accuracy, a transition of the number of evacuees for each evacuation shelter, a required amount of relief supplies, an operation status of transportation infrastructure, a relief supply delivery plan, and the like, and automatically generates an optimal relief supply delivery plan. Hereinafter, each component, a method of utilizing the generative AI, and role sharing between a server and a terminal will be described in detail with many specific examples. Specifically, the system operates on a distributed computing environment composed of a plurality of computing nodes. The system adopts a complex artificial intelligence architecture combining a large language model and a graph neural network. The system expands heterogeneous mixed data asynchronously transmitted from each organization on a memory as a multidimensional tensor. The system converts unstructured text data into a fixed-length embedding vector using natural language processing. The system constructs a spatiotemporal graph structure integrating spatial information and temporal information. The system executes a graph convolution operation. The system calculates a dependency relationship between nodes. The system extracts an important feature amount using a self-attention mechanism. The system outputs the transition of the number of evacuees for each evacuation shelter to be predicted as a time-series numerical array. The system outputs the required amount of relief supplies as a probability distribution for each item. The system outputs the operation status of transportation infrastructure as a weight coefficient of an edge. The system inputs these output results to a reinforcement learning agent. The system executes a reward maximization calculation based on a Markov decision process. The system automatically generates the optimal relief supply delivery plan as a node transition sequence. The system transfers the generated plan to a subsequent visualization module. The system completely eliminates a conventional planning process depending on human intuition and experience. The system solves a nonlinear optimization problem in a high-dimensional space in milliseconds. The system dramatically improves a processing speed while suppressing consumption of computing resources. The system prevents a fatal delay in a use case with extremely severe time constraints such as disaster response. The system is applied to a logistics optimization field in the event of a wide-area disaster. The system simultaneously evaluates a plurality of alternative delivery routes. The system executes robust optimization considering a road disruption probability. The system uses a linear combination of a cross-entropy error and a mean square error as a loss function. The system dynamically updates a weight of a network by a gradient descent method. The system thereby continuously improves prediction accuracy.

First, the data collection and integration unit collects, in real time, person movement data (e.g., location information of mobile terminals, boarding/alighting histories of transportation IC cards, GPS data of vehicles), transportation infrastructure operation status data (e.g., road closure information, operation statuses of railways and buses, damage statuses of bridges and tunnels), evacuation shelter capacity data (e.g., real-time number of people in an evacuation shelter entry/exit management system, age groups, information on people requiring special care), relief supply inventory data (e.g., inventory amounts of stockpile warehouses of each local government, consumption paces, expiration date information), disaster occurrence information data (e.g., breaking news from seismometers and weather radars, disaster reports from SNS and reporting applications), operation statuses of medical institutions (e.g., number of beds, medicine inventory, number of transportable patients), operation statuses of communication infrastructure (e.g., availability of base stations, communication failure areas), and the like held by local governments, transportation operators, infrastructure administrators, evacuation shelter operators, logistics operators, medical institutions, meteorological observation organizations, communication operators, and the like nationwide. These data are aggregated on the server side by various means such as API linkage, IoT sensors, data linkage with existing business systems, manual input from a terminal by a person in charge at a site, and automatic collection by image recognition and voice recognition. For example, when a person in charge at an evacuation shelter site inputs the number of evacuees and required relief supplies using a tablet terminal, takes a photograph, and uploads the photograph, a situation at the site is immediately reflected on the server. Furthermore, image data of a disaster-stricken area by a drone or a surveillance camera is also automatically collected, and collapsed buildings and an inundation range are extracted by image analysis using AI. Specifically, the data collection and integration unit receives millions of stream data per second using a distributed message queuing system. The data collection and integration unit temporarily stores the received data in an in-memory database. The data collection and integration unit expresses the person movement data as a three-dimensional vector including latitude and longitude and a time stamp. The data collection and integration unit expresses the transportation infrastructure operation status data as an edge attribute tensor of a graph structure. The data collection and integration unit expresses the evacuation shelter capacity data as a scalar value array of an integer type. The data collection and integration unit expresses the relief supply inventory data as a dictionary-type data structure composed of a pair of an item ID and a quantity. The data collection and integration unit acquires the disaster occurrence information data as a natural language text. The data collection and integration unit acquires the operation status of the medical institution as a multidimensional numerical vector. The data collection and integration unit acquires the operation status of the communication infrastructure as an array of binary flags. The data collection and integration unit maps these heterogeneous data to a common spatiotemporal coordinate system. The data collection and integration unit complements a missing value by a linear interpolation algorithm. The data collection and integration unit excludes an outlier by a statistical anomaly detection algorithm. The data collection and integration unit normalizes the data for which preprocessing has been completed. The data collection and integration unit converts the normalized data into a 512-dimensional feature vector. The data collection and integration unit applies a convolutional neural network to the image data. The data collection and integration unit receives an input image tensor as, for example, a 3-channel RGB image with a resolution of 224 by 224. The data collection and integration unit outputs a continuous value score between 0 and 1 indicating a collapse probability of a building from the image. The data collection and integration unit outputs a segmentation mask indicating the inundation range. The data collection and integration unit outputs a coordinate array of a bounding box indicating an occurrence location of a fire. The data collection and integration unit transfers these output results to the subsequent digital twin generation and update unit. The data collection and integration unit completely eliminates a delay in data input by human manual work. The data collection and integration unit utilizes a dedicated tensor operation processor to improve an inference speed of a machine learning model. The data collection and integration unit dramatically enhances comprehensiveness and real-time property of data collection. The data collection and integration unit is applied to a use case of situation grasping and infrastructure monitoring in the event of a wide-area disaster. The data collection and integration unit automatically resolves a contradiction among a plurality of data sources using a Kalman filter. The data collection and integration unit mathematically guarantees reliability of the data.

Next, the digital twin generation and update unit reproduces states of real-world cities and regions in a virtual space with high accuracy on a nationwide and regional basis using the wide variety of data obtained from the data collection and integration unit on the server side. For example, map data acquired from a geographic information system, 3D models of buildings, road networks, topographical data of rivers and mountains, location information of evacuation shelters, population distribution data, locations and operation statuses of critical infrastructure (power plants, substations, water and sewage facilities, communication base stations, etc.), and the like are integrated to faithfully reproduce the state of the real world. When a disaster occurs, an influence range of an earthquake, a flood, a landslide disaster, a tsunami, a fire, a power outage, a large-scale communication failure, or the like is simulated, and damage estimation, impassable sections, isolated areas, accommodatable numbers of people in evacuation shelters, operation statuses of medical institutions, operation statuses of logistics bases, and the like are immediately reflected on the digital twin. For example, when an earthquake with a seismic intensity of 7 occurs, building damage prediction around an epicenter, road disruption statuses, bridge damage, railway suspended sections, accommodatable numbers of people in evacuation shelters, occurrence of isolated settlements, numbers of acceptable patients in medical institutions, and the like are immediately calculated and displayed in the virtual space. Furthermore, in the case of a typhoon or heavy rain, a river flooding simulation and prediction of an inundation range are also performed. Specifically, the digital twin generation and update unit constructs a voxel grid data structure for managing three-dimensional spatial information on a memory. The digital twin generation and update unit allocates the collected feature vector to each voxel. The digital twin generation and update unit executes a physics engine that imitates physical laws of the real world. The digital twin generation and update unit calculates propagation of a seismic wave using a finite element method. The digital twin generation and update unit simulates resonance between a natural frequency of a building and a seismic wave. The digital twin generation and update unit calculates river flooding using a computational fluid dynamics model based on a shallow water equation. The digital twin generation and update unit inputs these physical simulation results to a graph neural network. The digital twin generation and update unit uses a 1024-dimensional tensor including geographical coordinates and attribute information of each node as input data. The digital twin generation and update unit inputs an adjacency matrix indicating a connection relationship of edges. The digital twin generation and update unit dynamically calculates a degree of influence between nodes using a graph attention network. The digital twin generation and update unit generates a numerical vector indicating a function stop probability of each infrastructure facility as an output. The digital twin generation and update unit outputs a binary mask tensor indicating an impassable section of a road. The digital twin generation and update unit outputs a heat map image indicating an occurrence probability of an isolated area. The digital twin generation and update unit provides these output results to the subsequent disaster response prediction and simulation unit. The digital twin generation and update unit eliminates damage estimation depending on human imagination. The digital twin generation and update unit strictly calculates a complex interaction in a high-dimensional space. The digital twin generation and update unit dramatically improves spatial resolution of a simulation compared to a conventional method. The digital twin generation and update unit offloads a calculation load to a distributed processing cluster. The digital twin generation and update unit enables visualization of a damage situation in real time. The digital twin generation and update unit is applied to a use case of formulation of a city plan and disaster prevention training. The digital twin generation and update unit automatically generates a scenario of a complex disaster in which a plurality of disasters are chained. The digital twin generation and update unit quantifies uncertainty using a Monte Carlo method. The digital twin generation and update unit calculates a confidence interval of prediction.

The disaster response prediction and simulation unit uses the generative AI as an essential component on the server side, and predicts and simulates, with high accuracy, a transition of the number of evacuees for each evacuation shelter, a required amount of relief supplies, an operation status of transportation infrastructure, a relief supply delivery plan, and the like from past disaster data and current real-time data. For example, the generative AI that has learned transitions of the number of evacuees and relief supply consumption patterns during past earthquakes, opening timings of evacuation shelters, and relief supply consumption tendencies for each attribute of evacuees (medicines and nursing care products for the elderly, milk and disposable diapers for infants, sanitary products for women, etc.) automatically calculates the number of evacuees and quantities of necessary food, water, blankets, medicines, sanitary products, winter clothing, generators, fuel, communication equipment, and the like for the next few hours to few days for each evacuation shelter also in the current disaster. In addition, based on damage statuses of roads and railways, passability and required time of a relief supply transportation route are also simulated. For example, when a main road is disrupted, a search for an alternative route and necessity of air transportation by a helicopter or a drone are also automatically determined. Furthermore, the generative AI continuously learns distributed data nationwide using federated learning, and is capable of flexibly responding to unknown disaster patterns and region-specific issues. For example, a special disaster pattern that occurred in the past in a certain region, a fluctuation in relief supply demand required only in a specific region, seasonal factors (heating equipment in winter, cooling equipment and heatstroke countermeasures in summer), an increase in demand for masks and disinfectants during an epidemic of an infectious disease, and the like are also reflected in a model by federated learning. Specifically, the disaster response prediction and simulation unit includes a large language model based on an autoregressive transformer architecture as a core. The disaster response prediction and simulation unit receives a time-series tensor indicating a past disaster history as input data. The disaster response prediction and simulation unit receives current real-time data as an embedding vector. The disaster response prediction and simulation unit inputs a categorical variable indicating attribute information of an evacuation shelter by one-hot encoding. The disaster response prediction and simulation unit sets the number of dimensions of the input data to, for example, 768 dimensions. The disaster response prediction and simulation unit extracts a long-term dependency relationship in time-series data using a multi-head attention mechanism. The disaster response prediction and simulation unit executes nonlinear transformation using a feed-forward neural network. The disaster response prediction and simulation unit generates an array of floating-point numbers indicating a transition of the number of evacuees for the next 72 hours as an output. The disaster response prediction and simulation unit outputs the required amount of relief supplies as a demand prediction score for each item. The disaster response prediction and simulation unit outputs an estimated restoration time of transportation infrastructure as a probability distribution. The disaster response prediction and simulation unit transfers these output results to a subsequent relief supply delivery plan automatic generation unit. The disaster response prediction and simulation unit executes a federated learning algorithm. The disaster response prediction and simulation unit aggregates gradient information individually calculated by a computing node in each region to a central server. The disaster response prediction and simulation unit updates a weight of a global model using a federated averaging method. The disaster response prediction and simulation unit does not transmit raw data on a network. The disaster response prediction and simulation unit improves generalization performance of the model while protecting privacy. The disaster response prediction and simulation unit completely eliminates demand prediction based on a human rule of thumb. The disaster response prediction and simulation unit discovers a hidden correlation in a high-dimensional feature space. The disaster response prediction and simulation unit significantly reduces a prediction error in terms of a mean absolute error. The disaster response prediction and simulation unit is applied to a use case of formulation of a wide-area evacuation plan and optimal arrangement of stockpile relief supplies. The disaster response prediction and simulation unit incorporates a seasonal variation and a weather factor into the model as an external feature amount. The disaster response prediction and simulation unit uses a Poisson regression loss as a loss function. The disaster response prediction and simulation unit optimizes prediction accuracy of count data.

In the automatic generation of a relief supply delivery plan, the generative AI automatically generates an optimal relief supply delivery plan based on predicted relief supply demand, inventory at each base, road conditions, and operation statuses of transportation means such as trucks, helicopters, and drones. For example, when 5000 liters of water, 200 blankets, and 100 sets of medicines are in short supply at an evacuation shelter in City A, necessary relief supplies are aggregated from a nearest relief supply base or a stockpile warehouse of another local government, a passable road is selected, and a truck is arranged. When a main road is disrupted, an alternative route is searched for, and air transportation by a helicopter or a drone is combined as necessary. Delivery to a plurality of evacuation shelters is simultaneously optimized, and a delivery route and order, a required number of vehicles, an estimated time of arrival, a loading plan, driver assignment, a refueling plan, and the like are automatically calculated. Push-type support is also supported, and the generative AI automatically arranges essential relief supplies in order of priority without waiting for a request from a local government. For example, immediately after an earthquake occurs, necessities such as food, water, blankets, and medicines are automatically arranged based on the number of people in an evacuation shelter and a relief supply consumption speed, and a plan to deliver them via an optimal route is immediately formulated. Furthermore, when a truck being delivered encounters traffic congestion or a road closure, a route is recalculated in real time and notified to related parties. Specifically, the relief supply delivery plan automatic generation unit executes a deep reinforcement learning algorithm. The relief supply delivery plan automatic generation unit constructs an environment model based on a Markov decision process. The relief supply delivery plan automatic generation unit defines a relief supply shortage amount vector of each evacuation shelter and a current position coordinate tensor of each transportation vehicle as a state space. The relief supply delivery plan automatic generation unit defines a combination of a next destination node and a loaded relief supply amount of each vehicle as an action space. The relief supply delivery plan automatic generation unit sets a linear combination of a negative penalty for an arrival delay time of relief supplies and a negative penalty for a transportation cost as a reward function. The relief supply delivery plan automatic generation unit trains a policy network using a proximal policy optimization algorithm. The relief supply delivery plan automatic generation unit receives a 256-dimensional state vector indicating a current state as an input. The relief supply delivery plan automatic generation unit generates a softmax distribution indicating a selection probability of each action as an output. The relief supply delivery plan automatic generation unit outputs a baseline prediction of a scalar value indicating a value of the current state as an output. The relief supply delivery plan automatic generation unit outputs a sequence of node IDs indicating a specific delivery route as an output. The relief supply delivery plan automatic generation unit transfers these output results to the subsequent information sharing and visualization unit. The relief supply delivery plan automatic generation unit completely eliminates an intuitive vehicle allocation plan by a human dispatcher. The relief supply delivery plan automatic generation unit solves a traveling salesperson problem causing a combinatorial explosion at high speed by a hybrid method of a heuristic search and a neural network. The relief supply delivery plan automatic generation unit reduces a calculation time from an exponential order to a polynomial order. The relief supply delivery plan automatic generation unit is applied to a use case of emergency transportation or last-mile delivery in the event of a disaster. The relief supply delivery plan automatic generation unit immediately executes recalculation when road closure information is updated. The relief supply delivery plan automatic generation unit realizes dynamic routing. The relief supply delivery plan automatic generation unit optimizes a multimodal transportation plan combining a plurality of transportation means. The relief supply delivery plan automatic generation unit uses a constraint satisfaction problem solver in combination. The relief supply delivery plan automatic generation unit guarantees a solution that strictly satisfies hard constraints such as a loaded weight limit and a driver's working hour limit.

The information sharing and visualization unit distributes information such as relief supply needs, inventory statuses, delivery plans, and transportation progress for each evacuation shelter generated on the server side to a dashboard screen or a map display screen on the terminal side in real time. For example, a relief supply shortage status of evacuation shelters nationwide, a current position of a truck being delivered, an estimated time of arrival, a transition of the number of evacuees for each evacuation shelter, a relief supply consumption pattern, an operation status of transportation infrastructure, the number of acceptable patients in medical institutions, an occurrence status of isolated settlements, and the like are visualized on a map. Related parties can immediately grasp a situation from a terminal (a personal computer, a tablet, a smartphone, etc.) and make a decision such as additional arrangement or route change as necessary. For example, when the number of evacuees rapidly increases at a certain evacuation shelter, if a person in charge at a site inputs information from a terminal, the generative AI immediately predicts new relief supply demand on the server side, automatically updates a delivery plan, and notifies terminals of related parties. Furthermore, it is also possible to display a relief supply consumption pace and a remaining inventory amount of each evacuation shelter in a graph on the dashboard, and visualize future shortage prediction and replenishment timing. Specifically, the information sharing and visualization unit establishes a bidirectional real-time communication session between the server and the terminal using a WebSocket protocol. The information sharing and visualization unit continuously transmits a data stream in a JSON format to a front-end rendering engine. The information sharing and visualization unit draws vector tile data on a screen using a map drawing library. The information sharing and visualization unit arranges an icon indicating a state of each evacuation shelter based on geographical coordinates. The information sharing and visualization unit superimposes and displays a relief supply shortage status as a color-coded heat map layer. The information sharing and visualization unit dynamically animates and displays a current position of a delivery truck based on time-series data of GPS coordinates. The information sharing and visualization unit displays an output result from the generative AI as a natural language summary text on a side panel of the screen. The information sharing and visualization unit receives a screen operation event from a user as an input. The information sharing and visualization unit analyzes the operation event and calculates bounding box coordinates of a display area. The information sharing and visualization unit selectively acquires only data included in the calculated coordinate range from the server. The information sharing and visualization unit generates an optimized graphical user interface on a terminal screen of the user as an output. The information sharing and visualization unit generates a pop-up window of detailed information displayed when a specific evacuation shelter is clicked as an output. The information sharing and visualization unit generates a time-series line graph indicating a relief supply consumption pace as an output. The information sharing and visualization unit directly provides these output results to a visual cognitive process of the user. The information sharing and visualization unit completely eliminates a work in which a human manually aggregates a huge amount of raw data. The information sharing and visualization unit dramatically improves visibility and understanding speed of information. The information sharing and visualization unit executes a data compression algorithm for minimizing consumption of a network bandwidth. The information sharing and visualization unit is applied to a use case of a huge screen display of a disaster response headquarters or a mobile terminal display of a person in charge at a site. The information sharing and visualization unit dynamically adjusts the number of polygons for drawing according to a screen resolution and processing capability of the terminal. The information sharing and visualization unit executes level-of-detail control. The information sharing and visualization unit always maintains responsiveness of the user interface in milliseconds.

In addition, actual disaster response data and new event data are continuously learned by federated learning on the server side, and simulation accuracy and a prediction model of the generative AI evolve. For example, the AI learns a relief supply amount actually required in the current disaster, a required delivery time, movements of evacuees, acceptance statuses of medical institutions, a restoration speed of communication infrastructure, and the like, and highly accurate prediction and planning become possible in the next and subsequent disasters. Characteristics of each region and past lessons are also reflected in the model. For example, characteristics of each region, such as an increase in demand for heating equipment and winter clothing in a heavy snowfall area in winter, easy occurrence of a delivery delay due to traffic congestion in an urban area, easy occurrence of an isolated settlement in a mountainous area, and an increase in demand for avoiding crowding in evacuation shelters and sanitary products during an epidemic of an infectious disease, are learned, and an optimal plan considering these is automatically generated in the next disaster. Specifically, the federated learning evolution unit operates based on a distributed machine learning framework. The federated learning evolution unit distributes an initialized weight parameter of a neural network to a computing node in each region. The federated learning evolution unit executes learning by a gradient descent method using actual disaster response data locally collected in each computing node. The federated learning evolution unit uses a numerical vector indicating an actual relief supply consumption amount or a scalar value indicating a required delivery time as input data. The federated learning evolution unit calculates a mean square error between a predicted value and an actual value as a loss function. The federated learning evolution unit calculates a weight gradient of each layer using an error backpropagation method. The federated learning evolution unit encrypts the calculated gradient tensor. The federated learning evolution unit transmits the encrypted gradient tensor to a central aggregation server. The federated learning evolution unit executes secure multi-party computation in the aggregation server. The federated learning evolution unit adds and averages the gradient tensor from each node without decrypting it. The federated learning evolution unit generates an updated weight parameter tensor of a global model as an output. The federated learning evolution unit generates a transition graph of a loss value indicating learning progress of each node as an output. The federated learning evolution unit generates an evaluation index score indicating generalization performance of the model as an output. The federated learning evolution unit applies these output results to a next inference cycle. The federated learning evolution unit completely eliminates a conventional centralized learning approach that concentrates raw data in one place. The federated learning evolution unit simultaneously achieves protection of data privacy and saving of a communication bandwidth. The federated learning evolution unit introduces a personalized federated learning algorithm considering a bias of a region-specific data distribution. The federated learning evolution unit dynamically blends a local model optimized for characteristics of each region and a general-purpose global model. The federated learning evolution unit improves accuracy of zero-shot inference for an unknown disaster pattern. The federated learning evolution unit is applied to a use case of construction of a nationwide disaster prevention network or wide-area linkage of medical data. The federated learning evolution unit detects a poisoning attack from a malicious node. The federated learning evolution unit automatically excludes an abnormal gradient vector by a robust aggregation algorithm. The federated learning evolution unit mathematically guarantees security and integrity of the model.

Furthermore, the generative AI plays an essential role as a core of the entire system, such as prediction of the number of evacuees and relief supply demand, optimization of a delivery plan, automatic summarization of information and decision-making support, model evolution by federated learning, automation of information collection in the event of a disaster (information extraction from SNS and reporting applications, damage situation grasping by image recognition), presentation of advice to a person in charge at a site (for example, “Since there are many elderly people in this evacuation shelter, please replenish medicines and nursing care products preferentially”), automatic generation and customization of a disaster response manual, and communication support among related parties (inquiry response and decision-making support by a chatbot). Specifically, the generative AI forming the core of the system is implemented as a huge transformer model having hundreds of billions of parameters. The generative AI has an ability to process multimodal input data. The generative AI receives a text prompt indicating a situation of an evacuation shelter as an input. The generative AI receives an image tensor indicating a damage situation at a site as an input. The generative AI receives a time-series numerical array from a sensor as an input. The generative AI projects these heterogeneous data onto a common latent space vector. The generative AI fuses feature amounts of text and an image using a cross-attention mechanism. The generative AI generates structured JSON data indicating relief supply demand prediction for each evacuation shelter as an output. The generative AI generates a natural language text indicating a specific action instruction to a person in charge at a site as an output. The generative AI generates a document in a markdown format indicating a summary report of a damage situation as an output. The generative AI asynchronously distributes these output results to each submodule in the system. The generative AI completely substitutes an interpretation and judgment process of information by a human operator. The generative AI executes a complex inference task in parallel while retaining high-dimensional context information. The generative AI reduces processing latency to the utmost limit. The generative AI is applied to a use case of dynamic generation of a disaster response manual or an interactive interface by a chatbot. The generative AI integrates a retrieval-augmented generation technology. The generative AI extracts a related past disaster case from an external vector database by a similarity search. The generative AI adds the extracted case as a context of a prompt. The generative AI probabilistically suppresses generation of an output not based on a fact called hallucination. The generative AI ensures reliability of an output from a viewpoint of information retrieval. The generative AI aligns an output of the model with human intention using human feedback from reinforcement learning. The generative AI guarantees ethical and safe decision-making support.

In this way, the system of the present invention is configured such that the server side mainly takes charge of data collection, integration, analysis, simulation, plan generation, and learning, and the terminal side takes charge of data input from a site, situation grasping by a dashboard, decision-making support, notification reception, uploading of photograph and voice data at a site, alert notification to a person in charge at a site, relief supply receipt confirmation and delivery completion reporting at a site, and the like, thereby optimizing disaster response on a nationwide scale in real time and fundamentally solving issues of local governments and related organizations. The generative AI, as the core of the entire system, becomes a one-and-only social infrastructure that realizes prompt and accurate support for disaster victims without depending on conventional manual work or personal judgment. Specifically, the system adopts a hierarchical distributed processing architecture in which a cloud computing environment and an edge device are linked. The system executes a large-scale matrix operation and an inference task of a deep learning model on a cluster of graphics processing units on the server side. The system executes edge computing using a lightweight inference model on the terminal side. The system receives an asynchronous data stream from a site terminal as an input. The system receives high-frequency sampling data from various sensors as an input. The system outputs a system log indicating an operation status of the entire system as an output. The system outputs metrics data indicating a processing delay time of each submodule as an output. The system outputs a multidimensional data structure indicating an overall picture of an optimized disaster response plan as an output. The system transfers these output results to a monitoring dashboard of a system administrator. The system completely eliminates personal information transmission based on conventional manual data transcription and telephone contact. The system guarantees consistency and immediacy of data in the entire system. The system adopts a microservices architecture. The system deploys each functional module as an independent container. The system dynamically autoscales the number of replicas of a container according to an increase or decrease in load. The system maintains availability of the system against sudden access concentration at 99.99 percent or more. The system is applied to a use case of national-scale wide-area disaster response or crowd control of a large-scale event. The system causes the generative AI to function not merely as a text generation tool but as a control orchestrator of the entire system. In the system, the AI autonomously routes a data flow between respective modules. In the system, the AI dynamically optimizes allocation of hardware resources. The system dramatically improves autonomy and self-healing capability of a computer system itself. The system realizes a fundamental improvement of an information processing technology.

### System Configuration

The system according to the present embodiment comprises a data collection and integration unit, a digital twin generation and update unit, a disaster response prediction and simulation unit, a relief supply delivery plan automatic generation unit, an information sharing and visualization unit, a federated learning evolution unit, an on-site input support unit, an alert notification unit, and a generative AI prompt management unit.

The data collection and integration unit collects, in real time, various data such as person movement data, transportation infrastructure operation status data, evacuation shelter capacity data, relief supply inventory data, disaster occurrence information data, operation statuses of medical institutions, operation statuses of communication infrastructure, disaster report data from SNS and reporting applications, and image data from drones and surveillance cameras held by local governments, transportation operators, infrastructure administrators, evacuation shelter operators, logistics operators, medical institutions, meteorological observation organizations, communication operators, and the like nationwide, aggregates the data on the server side through API linkage, IoT sensors, data linkage with existing business systems, manual input from a terminal by an on-site person in charge, automatic collection by image recognition and voice recognition, and the like, and integrates the data after applying encryption and anonymization processing. Examples include a case where an on-site person in charge of an evacuation shelter inputs the number of evacuees and required relief supplies using a tablet terminal, takes a photograph, and uploads the photograph, whereby an on-site situation is immediately reflected on the server, a case where closed sections, traffic congestion information, and current positions of trucks are automatically acquired from a road management system, a case where disaster occurrence information such as an earthquake or a typhoon is immediately acquired from a meteorological observation system, and a case where an aerial image of a disaster-stricken area by a drone is extracted as collapsed buildings and an inundation range by AI image analysis. Specifically, the data collection and integration unit implements a distributed stream processing engine. The data collection and integration unit receives a payload transmitted from each data source by serializing the payload in a protocol buffer format. The data collection and integration unit receives an N-by-3 floating-point tensor including person movement data as input data. The data collection and integration unit receives a 4K resolution video stream from a drone as input data. The data collection and integration unit receives a variable-length character string array including SNS text posts as input data. The data collection and integration unit applies end-to-end encryption to these data using an advanced encryption standard algorithm. The data collection and integration unit irreversibly anonymizes personal information using a hash function. The data collection and integration unit applies a single-pass real-time object detection neural network to image data. The data collection and integration unit generates a coordinate tensor of a bounding box surrounding a collapsed building in an image as an output. The data collection and integration unit generates a pair of a class label and a confidence score for each bounding box as an output. The data collection and integration unit generates an appearance frequency vector of disaster keywords extracted from SNS text as an output. The data collection and integration unit loads these output results into a subsequent data warehouse. The data collection and integration unit completely eliminates visual image confirmation and manual data cleansing work by humans. The data collection and integration unit executes an initial filtering process on an edge device side. The data collection and integration unit dramatically reduces consumption of network bandwidth to a central server. The data collection and integration unit is applied to use cases of a city monitoring system of a smart city and wide-area infrastructure maintenance. The data collection and integration unit synchronizes time-series data having different sampling rates on a time axis using a dynamic time warping algorithm. The data collection and integration unit improves accuracy of correlation analysis between heterogeneous data. The data collection and integration unit executes an isolation forest algorithm as an anomaly detection model. The data collection and integration unit blocks invalid data caused by a sensor failure or noise in real time.

The digital twin generation and update unit reproduces states of real-world cities and regions in a virtual space with high accuracy on a nationwide and regional basis using the wide variety of data obtained from the data collection and integration unit. For example, map data acquired from a geographic information system, 3D models of buildings, road networks, topographical data of rivers and mountains, location information of evacuation shelters, population distribution data, locations and operation statuses of critical infrastructure, and the like are integrated to faithfully reproduce the state of the real world. When a disaster occurs, an influence range of an earthquake, a flood, a landslide disaster, a tsunami, a fire, a power outage, a large-scale communication failure, or the like is simulated, and damage estimation, impassable sections, isolated areas, the capacity of evacuation shelters, operation statuses of medical institutions, operation statuses of logistics bases, and the like are immediately reflected on the digital twin. Examples include a case where, when an earthquake with a seismic intensity of 7 occurs, building damage prediction around an epicenter, road disruption statuses, bridge damage, railway suspended sections, the capacity of evacuation shelters, occurrence of isolated settlements, the number of acceptable patients in medical institutions, and the like are immediately calculated and displayed in the virtual space, a case where a river flooding simulation and an inundation range prediction are performed in the event of a typhoon or heavy rain, a case where a prospect of restoration of power infrastructure is visualized when a power outage occurs, and a case where an operation status of communication infrastructure is reflected on a map when a communication failure occurs. Specifically, the digital twin generation and update unit hierarchically divides and manages a three-dimensional virtual space using an octree algorithm as a spatial index structure. The digital twin generation and update unit receives a point cloud tensor including three-dimensional coordinates and attribute information of each infrastructure facility as input data. The digital twin generation and update unit receives grid data of wind speed and precipitation from a weather simulation model as input data. The digital twin generation and update unit receives acceleration waveform data from a seismometer as input data. The digital twin generation and update unit integrates these input data and executes a multiphysics simulation. The digital twin generation and update unit generates a continuous value score from 0 to 100 indicating a structural damage degree of each building as an output. The digital twin generation and update unit generates a weight matrix indicating a passable probability of each edge on a road network as an output. The digital twin generation and update unit generates a two-dimensional floating-point matrix indicating a spatial distribution of inundation depth as an output. The digital twin generation and update unit transfers these output results to the subsequent disaster response prediction and simulation unit and information sharing and visualization unit. The digital twin generation and update unit completely eliminates a conventional analog damage estimation method based on a static two-dimensional map. The digital twin generation and update unit maximizes parallel computing capability of a graphics processing unit. The digital twin generation and update unit completes complex physical calculations in which millions of objects interact in real time. The digital twin generation and update unit is applied to use cases of constructing a virtual test environment for autonomous vehicles and environmental assessment of urban development. The digital twin generation and update unit executes a sensitivity analysis on an initial value of a simulation using a Markov chain Monte Carlo method. The digital twin generation and update unit probabilistically generates a worst-case scenario and a best-case scenario of damage prediction. The digital twin generation and update unit supports decision-making under a situation involving uncertainty based on mathematical grounds. The digital twin generation and update unit updates only time-series difference data on a memory. The digital twin generation and update unit minimizes consumption of computing resources.

The disaster response prediction and simulation unit uses generative AI as an essential component, and predicts and simulates, with high accuracy, a transition of the number of evacuees for each evacuation shelter, a required amount of relief supplies, an operation status of transportation infrastructure, a relief supply delivery plan, and the like from past disaster data and current real-time data. Examples include a case where the generative AI that has learned transitions of the number of evacuees, relief supply consumption patterns, opening timings of evacuation shelters, and relief supply consumption trends for each attribute of evacuees during past earthquakes automatically calculates the number of evacuees and quantities of necessary food, water, blankets, medicines, sanitary goods, winter clothing, generators, fuel, communication devices, and the like for the next few hours to few days for each evacuation shelter even in the current disaster, a case where passability and required time of a relief supply transportation route are simulated based on damage statuses of roads and railways, a case where a search for an alternative route and the necessity of air transportation by a helicopter or a drone are automatically determined when a main road is disrupted, and a case where avoidance of crowding in evacuation shelters and an increase in demand for sanitary goods are predicted during an infectious disease epidemic. Specific examples of a prompt sentence to be read by the generative AI include “Predict a required amount of relief supplies and an optimal delivery route for each evacuation shelter for the next 24 hours based on the latest evacuation shelter entry/exit data, relief supply inventory data, and road traffic status data,” “Simulate a transition of the number of evacuees and a change in relief supply demand for the next 72 hours based on earthquake disaster data for the past 10 years, a current population distribution in a disaster-stricken area, and an operation status of transportation infrastructure,” and “Predict quantities of necessary medicines, milk, disposable diapers, and nursing care products and formulate an optimal delivery plan when there are many elderly people and infants in an evacuation shelter in City A.” Specifically, the disaster response prediction and simulation unit adopts a hybrid architecture integrating a long short-term memory network, which is a type of recurrent neural network, and a large language model. The disaster response prediction and simulation unit receives a multivariate time-series tensor indicating a transition of the number of evacuees during past disasters as input data. The disaster response prediction and simulation unit receives a context vector indicating current weather conditions and infrastructure damage statuses as input data. The disaster response prediction and simulation unit receives a prompt sentence described in natural language as input data. The disaster response prediction and simulation unit converts the prompt sentence into an integer index array by a tokenizer. The disaster response prediction and simulation unit generates a predicted value of the number of evacuees on an hourly basis for the next 72 hours in each evacuation shelter as a floating-point matrix as an output. The disaster response prediction and simulation unit generates dictionary-type data consisting of a pair of an item ID and a requested amount of a necessary relief supply as an output. The disaster response prediction and simulation unit generates a natural language text string explaining grounds for prediction as an output. The disaster response prediction and simulation unit transfers these output results to the subsequent relief supply delivery plan automatic generation unit. The disaster response prediction and simulation unit completely eliminates heuristic demand prediction by a human expert. The disaster response prediction and simulation unit models a complex interaction between a past pattern and a current situation in a high-dimensional nonlinear space. The disaster response prediction and simulation unit significantly reduces a mean squared error of prediction compared to a conventional statistical model. The disaster response prediction and simulation unit is applied to use cases of pandemic prediction of infectious diseases and demand prediction of a supply chain. The disaster response prediction and simulation unit analyzes an attention weight. The disaster response prediction and simulation unit specifies which input feature amount contributed most to a prediction result. The disaster response prediction and simulation unit ensures interpretability of a deep learning model that tends to be a black box. The disaster response prediction and simulation unit calculates uncertainty during inference in a Bayesian estimation manner using a dropout method. The disaster response prediction and simulation unit dynamically outputs a confidence interval of prediction.

The relief supply delivery plan automatic generation unit automatically generates an optimal relief supply delivery plan based on relief supply demand predicted by the generative AI, inventory at each base, road conditions, and operation statuses of transportation means such as trucks, helicopters, and drones. Examples include a case where, when 5000 liters of water, 200 blankets, and 100 sets of medicines are in short supply at an evacuation shelter in City A, necessary relief supplies are aggregated from a nearest relief supply base or a stockpile warehouse of another local government, a passable road is selected, and a truck is arranged, a case where an alternative route is searched for when a main road is disrupted, and air transportation by a helicopter or a drone is combined as necessary, a case where delivery to a plurality of evacuation shelters is simultaneously optimized, and a delivery route and order, a required number of vehicles, an estimated time of arrival, a loading plan, driver assignment, a refueling plan, and the like are automatically calculated, and a case where a route is recalculated in real time and notified to related parties when a truck being delivered encounters traffic congestion or a road closure. Specifically, the relief supply delivery plan automatic generation unit executes a routing optimization engine combining a graph neural network and deep reinforcement learning. The relief supply delivery plan automatic generation unit receives a node feature amount matrix indicating a relief supply demand amount of each evacuation shelter as input data. The relief supply delivery plan automatic generation unit receives an edge feature amount tensor indicating a passable probability and a travel time of a road as input data. The relief supply delivery plan automatic generation unit receives a state vector indicating a loading capacity and a current position of each transportation vehicle as input data. The relief supply delivery plan automatic generation unit learns an optimal policy using an actor-critic algorithm. The relief supply delivery plan automatic generation unit generates a sequence of integer values indicating an ID of a node to be visited next by each vehicle as an output. The relief supply delivery plan automatic generation unit generates a continuous value vector indicating an amount of relief supplies to be unloaded at each node as an output. The relief supply delivery plan automatic generation unit generates a scalar value indicating an evaluation score of the entire plan as an output. The relief supply delivery plan automatic generation unit transfers these output results to the subsequent information sharing and visualization unit and alert notification unit. The relief supply delivery plan automatic generation unit completely eliminates routing based on a rule of thumb by a human dispatcher. The relief supply delivery plan automatic generation unit recalculates a plan in milliseconds for dynamically changing traffic conditions and new relief supply demand. The relief supply delivery plan automatic generation unit solves a trade-off between transportation cost and delivery delay from a viewpoint of Pareto optimality. The relief supply delivery plan automatic generation unit is applied to use cases of dynamic delivery route optimization of home delivery services and a dispatch system of on-demand public transportation. The relief supply delivery plan automatic generation unit integrates a constraint programming solver into an output layer of a neural network. The relief supply delivery plan automatic generation unit guarantees a feasible solution that absolutely does not violate physical and legal hard constraints such as a maximum loading capacity of a vehicle and a continuous driving time limit of a driver. The relief supply delivery plan automatic generation unit introduces multi-agent reinforcement learning. The relief supply delivery plan automatic generation unit realizes autonomous decentralized control in which a plurality of vehicles maximize overall delivery efficiency while cooperating with each other.

The information sharing and visualization unit distributes, in real time, information such as relief supply needs, inventory statuses, delivery plans, and transportation progress for each evacuation shelter generated on the server side to a dashboard screen or a map display screen on the terminal side. Examples include a case where a relief supply shortage status of evacuation shelters nationwide, a current position of a truck being delivered, an estimated time of arrival, a transition of the number of evacuees for each evacuation shelter, a relief supply consumption pattern, an operation status of transportation infrastructure, the number of acceptable patients in medical institutions, an occurrence status of isolated settlements, and the like are visualized on a map, a case where related parties can immediately grasp a situation from a terminal and make a decision such as additional arrangement or route change as necessary, a case where a relief supply consumption pace and a remaining inventory amount of each evacuation shelter are displayed in a graph on a dashboard to visualize future shortage prediction and replenishment timing, and a case where, when an on-site person in charge inputs information from a terminal, the generative AI immediately predicts new relief supply demand on the server side, automatically updates a delivery plan, and notifies terminals of related parties. Specifically, the information sharing and visualization unit constructs an asynchronous data flow processing pipeline based on a reactive programming paradigm. The information sharing and visualization unit receives an update event stream in a JSON format push-distributed from the server side as input data. The information sharing and visualization unit receives a normalized scalar value between 0 and 1 indicating a relief supply sufficiency rate of each evacuation shelter as input data. The information sharing and visualization unit receives a time-series array of GPS coordinates of a delivery vehicle as input data. The information sharing and visualization unit stores these data in an in-memory state management store on a client side. The information sharing and visualization unit generates a difference tree of a virtual document object model as an output. The information sharing and visualization unit generates a vertex coordinate array of a polygon layer on a map as an output. The information sharing and visualization unit generates a control point parameter of a Bezier curve indicating a trend of relief supply consumption as an output. The information sharing and visualization unit draws these output results on a physical display through a graphics rendering API. The information sharing and visualization unit completely eliminates work in which a human manually collects data from a plurality of systems and aggregates the data using spreadsheet software. The information sharing and visualization unit immediately binds a data change to a visual element on a screen. The information sharing and visualization unit keeps a drawing delay of a user interface within a standard of 60 frames per second. The information sharing and visualization unit is applied to use cases of a real-time monitoring dashboard of a financial market and an IoT device monitoring system of a factory. The information sharing and visualization unit considers constraints on computing resources on the client side. The information sharing and visualization unit skips rendering of an object existing outside a screen by a culling process. The information sharing and visualization unit visually aggregates a large amount of data points using a clustering algorithm. The information sharing and visualization unit prevents a memory leak of a browser and guarantees long-term stable operation. The information sharing and visualization unit executes a layout optimization algorithm that minimizes a user's line-of-sight movement.

The federated learning evolution unit continuously learns actual disaster response data and new event data by federated learning on the server side to evolve simulation accuracy and a prediction model of the generative AI. Examples include a case where the AI learns an amount of relief supplies actually required in the current disaster, a required delivery time, movements of evacuees, acceptance statuses of medical institutions, a restoration speed of communication infrastructure, and the like, enabling highly accurate prediction and planning in subsequent disasters, a case where regional characteristics such as an increase in demand for heating appliances and winter clothing in heavy snowfall areas in winter, a tendency for delivery delays due to traffic congestion in urban areas, a tendency for isolated settlements to occur in mountainous areas, and an increase in demand for avoiding crowding in evacuation shelters and sanitary goods during an infectious disease epidemic are learned, and an optimal plan considering these is automatically generated in the next disaster, a case where distributed data nationwide are integrated by federated learning to flexibly respond to unknown disaster patterns and region-specific issues, and a case where a disaster response manual is automatically generated or customized. Specifically, the federated learning evolution unit adopts a distributed parameter server architecture implementing a secure multi-party computation protocol. The federated learning evolution unit receives a weight gradient tensor of a neural network calculated at each edge node as input data. The federated learning evolution unit receives a scalar value indicating a learning data size of each node as input data. The federated learning evolution unit receives a loss value for verification data of a local model as input data. The federated learning evolution unit executes an operation on these input data in a state where homomorphic encryption is applied. The federated learning evolution unit generates an aggregated weight parameter tensor of a global model as an output. The federated learning evolution unit generates a vector of Shapley values indicating a contribution degree of each node as an output. The federated learning evolution unit generates a setting value list of hyperparameters to be used in a next learning round as an output. The federated learning evolution unit broadcasts these output results to all participating nodes on a network. The federated learning evolution unit completely eliminates a conventional centralized data lake method that aggregates highly confidential personal information and medical data in a central server. The federated learning evolution unit physically prevents data from going out from an edge device. The federated learning evolution unit simultaneously solves conflicting issues of privacy protection and performance improvement of a machine learning model. The federated learning evolution unit is applied to use cases of joint learning of a medical image diagnosis model among a plurality of hospitals and sharing of a fraud detection model among financial institutions. The federated learning evolution unit overcomes a constraint of communication bandwidth. The federated learning evolution unit applies sparsification and quantization algorithms to a gradient tensor. The federated learning evolution unit compresses a communication data amount to 1 percent or less of an original size. The federated learning evolution unit applies a federated proximal algorithm to an edge node group having non-independent and identically distributed data characteristics. The federated learning evolution unit suppresses overfitting of a local model and dramatically improves a convergence speed of a global model.

The on-site input support unit provides an interface for an on-site person in charge to input and upload a situation of an evacuation shelter, an inventory status of relief supplies, a damage status, photographs, voice data, and the like from a terminal, and transmits the input data to the server side. Examples include a case where the number and attributes of people in an evacuation shelter, types and quantities of required relief supplies, on-site photographs and videos, voice memos, detailed descriptions of damage statuses, and the like are input from a tablet terminal or a smartphone, a case where relief supply receipt confirmation and a delivery completion report at a site are performed from a terminal, a case where an on-site person in charge quickly registers information utilizing voice input and image recognition, and a case where an alert notification and instruction reception at a site are confirmed on a terminal. Specifically, the on-site input support unit operates as a native application closely integrated with a hardware sensor of a mobile terminal. The on-site input support unit receives an audio stream in a PCM format indicating a user's voice utterance as input data. The on-site input support unit receives an RGB image tensor acquired from a camera of a terminal as input data. The on-site input support unit receives trajectory data of gesture coordinates from a touch screen as input data. The on-site input support unit executes a lightweight voice recognition neural network on an edge side. The on-site input support unit generates a structured JSON object by converting voice into text as an output. The on-site input support unit generates a feature amount vector extracted from an image as an output. The on-site input support unit generates a transaction record with a time stamp indicating completion of input as an output. The on-site input support unit transmits these output results to a central server via an asynchronous communication queue. The on-site input support unit completely eliminates handwritten input using a paper form and complicated character input work using a keyboard. The on-site input support unit temporarily stores data in a local database even in an offline environment. The on-site input support unit automatically executes a synchronization process at the moment a network connection is restored. The on-site input support unit prevents data loss under a harsh environment of a disaster-stricken area where communication infrastructure is unstable. The on-site input support unit is applied to use cases of a progress management system of a construction site and recording work of home-visit nursing care. The on-site input support unit executes real-time input completion and error checking using natural language processing on input text data. The on-site input support unit ensures quality of input data on the edge side. The on-site input support unit automatically reads a barcode and product name text printed on a cardboard box of relief supplies using optical character recognition technology. The on-site input support unit reduces an input load of inventory management to the utmost limit.

The alert notification unit notifies terminals of related parties, in real time, of alerts such as important information and anomaly detection from the generative AI and the entire system, a change in a delivery plan, a rapid increase in the number of people in an evacuation shelter, prediction of a shortage of relief supplies, occurrence of a road closure, an acceptance restriction of a medical institution, and occurrence of a communication failure. Examples include a case where an alert for additional relief supply arrangement is transmitted when the number of evacuees rapidly increases in an evacuation shelter, a case where an alert for a route change instruction is transmitted when a truck being delivered encounters a road closure, a case where a transportation instruction to a neighboring medical institution is notified when an acceptance restriction of a medical institution occurs, and a case where an alert prompting use of an alternative communication means is transmitted when a communication failure occurs. Specifically, the alert notification unit implements an event-driven messaging architecture based on a publish-subscribe model. The alert notification unit receives a JSON payload of an anomaly detection event issued from each module in the system as input data. The alert notification unit receives a device token and current position coordinates of a terminal of each user as input data. The alert notification unit receives profile data indicating a user's role and authority as input data. The alert notification unit executes a rule engine and a machine learning-based importance determination model. The alert notification unit generates a formatted message payload to be transmitted to a push notification service as an output. The alert notification unit generates a probability score between 0 and 1 indicating an urgency degree of an alert as an output. The alert notification unit generates a log record indicating a delivery history of a notification as an output. The alert notification unit delivers these output results to a target terminal with a delay in milliseconds. The alert notification unit completely eliminates inefficient monitoring work in which a human constantly visually checks a monitoring screen to search for an anomaly. The alert notification unit prevents occurrence of excessive notifications called an alert storm. The alert notification unit aggregates a plurality of similar alert events into a single notification based on temporal and spatial proximity. The alert notification unit significantly reduces a user's cognitive load. The alert notification unit is applied to use cases of an anomaly detection system of a plant and unauthorized access detection of a financial system. The alert notification unit tracks a read confirmation signal indicating whether a user has opened a notification. The alert notification unit autonomously executes a fallback process to SMS or an automatic voice call, which is an alternative communication means, when a notification is not opened within a certain period of time. The alert notification unit completely prevents omission of transmission of critical information at a system level.

The generative AI prompt management unit manages a prompt sentence necessary when utilizing the generative AI in the entire system, and provides an optimal prompt sentence to the generative AI according to a situation. For example, a prompt sentence for predicting relief supply demand and formulating a delivery plan for each evacuation shelter, a prompt sentence for a simulation instruction combining past disaster data and a current situation, a prompt sentence for an automatic response to an inquiry from an on-site person in charge, a prompt sentence for an automatic generation instruction of a disaster response manual, and the like are managed and provided to the generative AI as necessary. Specific prompt sentences include “Predict a required amount of relief supplies and an optimal delivery route for each evacuation shelter for the next 24 hours based on the latest evacuation shelter entry/exit data, relief supply inventory data, and road traffic status data,” “Predict quantities of necessary medicines, milk, disposable diapers, and nursing care products and formulate an optimal delivery plan when there are many elderly people and infants in an evacuation shelter in City A,” “Simulate a transition of the number of evacuees and a change in relief supply demand for the next 72 hours based on earthquake disaster data for the past 10 years, a current population distribution in a disaster-stricken area, and an operation status of transportation infrastructure,” and “Analyze a damage report photograph from a site, extract collapsed buildings and an inundation range, and summarize a damage status.” Specifically, the generative AI prompt management unit includes a dynamic template engine that automates a process of prompt engineering. The generative AI prompt management unit receives a dictionary of context variables indicating a current system state as input data. The generative AI prompt management unit receives a natural language query character string indicating a user's request intention as input data. The generative AI prompt management unit receives an evaluation metric indicating a success rate of a past prompt as input data. The generative AI prompt management unit searches for a similar past optimal prompt template using a vector database. The generative AI prompt management unit generates an optimized prompt character string to be input to a large language model as an output. The generative AI prompt management unit generates a list of parameters embedded in a prompt as an output. The generative AI prompt management unit generates an integer value indicating the number of tokens of a generated prompt as an output. The generative AI prompt management unit transmits these output results to an inference API of the generative AI. The generative AI prompt management unit completely eliminates personalized work in which a human manually adjusts a prompt through trial and error. The generative AI prompt management unit automatically summarizes and truncates input data so as not to exceed a limit of a context window. The generative AI prompt management unit maximizes output quality while minimizing an inference cost of a large language model. The generative AI prompt management unit is applied to use cases of an automatic response system for customer support and an automatic generation tool for program code. The generative AI prompt management unit executes a security filter for detecting a prompt injection attack. The generative AI prompt management unit sanitizes a malicious input character string. The generative AI prompt management unit blocks a risk of an AI model causing an unexpected operation at a system boundary. The generative AI prompt management unit continuously self-optimizes a configuration of a prompt using reinforcement learning.

As described above, the system according to the present embodiment becomes a one-and-only social infrastructure that realizes prompt and accurate support for disaster victims without depending on conventional manual work or personal judgment by optimizing nationwide disaster response in real time through cooperation of each unit and utilizing generative AI as a core. Specifically, the system forms an autonomous distributed information processing infrastructure in which the above-described sub-modules loosely couple and cooperate as microservices. The system receives terabyte-class streaming data per second from a nationwide sensor network as input data. The system receives asynchronous transaction data from tens of thousands of field personnel as input data. The system receives periodic batch data from open data APIs of external organizations as input data. The system processes these massive amounts of data in real time. The system generates a multidimensional decision tree indicating a national-level disaster response strategy as an output. The system generates an optimized matrix indicating resource allocation to each local government as an output. The system generates a health check report indicating a self-diagnosis result of the entire system as an output. The system automatically links these output results to core systems of the national government and local governments. The system enables information processing at a scale and speed exceeding human cognitive limits. The system integrates conventional siloed disaster prevention systems into a single intelligent platform. The system socially implements data-driven decision making. The system is applied to use cases of an operating system for a smart nation and a global climate change countermeasure platform. The system positions the generative AI not merely as a dialogue agent but as a cognitive engine that governs control of the entire system. The system highly fuses hardware computing power and software algorithms. The system embodies a paradigm shift in computer technology itself. The system provides the most robust and highly adaptable technical solution for protecting human life and property in a highly uncertain modern society. The system infinitely improves its performance over time through continuous machine learning.

### Implementation Steps

Step 1: Data Collection and Integration Various data such as person movement data, transportation infrastructure operation status data, evacuation shelter capacity data, relief supply inventory data, disaster occurrence information data, operation statuses of medical institutions, operation statuses of communication infrastructure, disaster report data from SNS and reporting applications, and image data from drones and surveillance cameras held by local governments, transportation operators, infrastructure administrators, evacuation shelter operators, logistics operators, medical institutions, meteorological observation organizations, communication operators, and the like nationwide are collected in real time, aggregated on the server side through API linkage, IoT sensors, data linkage with existing business systems, manual input from terminals by field personnel, automatic collection by image recognition and voice recognition, and the like, and integrated after being subjected to encryption and anonymization processing. Examples include a case where a field person in charge of an evacuation shelter inputs the number of evacuees and required relief supplies using a tablet terminal, takes a photograph, and uploads it, whereby the situation at the site is immediately reflected on the server, a case where closed sections, traffic congestion information, and current positions of trucks are automatically acquired from a road management system, a case where disaster occurrence information such as earthquakes and typhoons is immediately acquired from a meteorological observation system, and a case where aerial images of a disaster-stricken area by a drone are extracted as collapsed buildings and inundated areas by AI image analysis. Specifically, the data collection and integration unit executes a process of mapping heterogeneous multimodal data to a common high-dimensional vector space. The system receives data streams asynchronously transmitted from each data source. The processing unit automatically applies preprocessing of normalization and missing value imputation to the received raw data. The system executes data cleansing using an autoencoder-type neural network. Input data to the neural network is, for example, a one-dimensional time-series array of temperature and humidity acquired from each sensor, and an RGB image tensor with a resolution of 1920×1080 acquired from a drone. The neural network removes noise from these input data. Output data from the neural network is a 512-dimensional feature vector from which noise has been removed, and a probability score indicating an abnormal value. When the probability score exceeds a predetermined threshold, the processing unit executes a branching process of discarding the data as an abnormal value. The system transfers the feature vector determined to be normal to a subsequent digital twin generation module. The processing unit analyzes text data of SNS using a natural language processing model. Input data to the model is a word embedding vector obtained by tokenizing a user's posted text. Output data from the model is a categorization label indicating a type of disaster, and a floating-point number from 0 to 1 indicating a degree of urgency. The system dynamically changes a processing priority of data based on the degree of urgency. Through these processes, the system completely eliminates manual data confirmation work by humans. The system reduces data processing latency to the millisecond level. The system exhibits a technical effect of ensuring the quality of input data in subsequent AI inference and dramatically improving prediction accuracy. The system prevents downtime of the entire system even when massive traffic occurs during a wide-area disaster.
Step 2: Digital Twin Generation and Update Using the wide variety of data obtained from the data collection and integration unit, states of real-world cities and regions are reproduced in a virtual space with high accuracy on a nationwide and regional basis. Map data acquired from a geographic information system, 3D models of buildings, road networks, topographical data of rivers and mountains, location information of evacuation shelters, population distribution data, locations and operation statuses of critical infrastructure, and the like are integrated to faithfully reproduce the state of the real world. When a disaster occurs, an influence range of an earthquake, flood, landslide, tsunami, fire, power outage, large-scale communication failure, or the like is simulated, and damage assumptions, impassable sections, isolated areas, evacuation shelter capacities, operation statuses of medical institutions, operation statuses of logistics bases, and the like are immediately reflected on the digital twin. Examples include a case where, when an earthquake with a seismic intensity of 7 occurs, building damage predictions around the epicenter, road severance statuses, bridge damage, railway suspended sections, evacuation shelter capacities, occurrence of isolated settlements, the number of acceptable patients at medical institutions, and the like are immediately calculated and displayed in the virtual space, a case where river flooding simulation and inundation range prediction are performed in the event of a typhoon or heavy rain, a case where a prospect of restoration of power infrastructure is visualized when a power outage occurs, and a case where an operation status of communication infrastructure is reflected on a map when a communication failure occurs. Specifically, the digital twin generation and update unit mathematically models physical and logical structures of a city using a dynamic graph neural network. The system constructs a large-scale directed graph on a memory with intersections and evacuation shelters as nodes and roads and communication networks as edges. The processing unit binds attribute data that changes in real time to each node and edge. Input data to the neural network is a feature vector of each point output from the data collection and integration unit, and a spatial tensor indicating 3D coordinates of buildings. The neural network executes a message passing algorithm between adjacent nodes. Output data from the neural network is a score array from 0 to 1 indicating a damage probability of each node, and a weight matrix indicating an impassable probability of each edge. The processing unit dynamically updates a cost function of a shortest path search algorithm using the weight matrix. The system inputs the updated graph structure to a subsequent simulation engine. The simulation engine calculates an inundation range of a tsunami or river flooding using a fluid dynamics model. Input data to the engine is a two-dimensional grid tensor indicating elevation data of terrain, and a time-series vector indicating precipitation. Output data from the engine is a floating-point matrix indicating an inundation depth of each grid. The system transfers the matrix to a rendering pipeline and rewrites texture data in the virtual space. Through these processes, the system executes unconventional high-dimensional spatial operations different from conventional static database searches. The system calculates complex interactions of the entire city in real time. The system brings about a technical effect of significantly reducing the time required to grasp the situation when a disaster occurs and supporting prompt decision-making.
Step 3: Disaster Response Prediction and Simulation by Generative AI Using the generative AI as an essential component, a transition of the number of evacuees for each evacuation shelter, a required amount of relief supplies, an operation status of transportation infrastructure, a relief supply delivery plan, and the like are predicted and simulated with high accuracy from past disaster data and current real-time data. For example, the generative AI that has learned transitions of the number of evacuees, relief supply consumption patterns, evacuation shelter opening timings, and relief supply consumption trends for each attribute of evacuees during past earthquakes automatically calculates the number of evacuees and quantities of necessary food, water, blankets, medicines, sanitary goods, winter clothing, generators, fuel, communication equipment, and the like for the next few hours to few days for each evacuation shelter in the current disaster as well. Based on damage statuses of roads and railways, passability and required time of relief supply transportation routes are simulated. When a major road is severed, a search for an alternative route and the necessity of air transportation by a helicopter or a drone are automatically determined. Avoidance of crowding in evacuation shelters and an increase in demand for sanitary goods during an infectious disease epidemic are predicted. Specific examples of prompt sentences to be read into the generative AI include “Predict the required amount of relief supplies and an optimal delivery route for each evacuation shelter for the next 24 hours based on the latest evacuation shelter entry/exit data, relief supply inventory data, and road traffic status data,” “Simulate a transition of the number of evacuees and a change in relief supply demand for the next 72 hours based on earthquake disaster data for the past 10 years, current population distribution in the disaster-stricken area, and transportation infrastructure operation statuses,” and “When there are many elderly people and infants in an evacuation shelter in City A, predict quantities of necessary medicines, milk, disposable diapers, and nursing care products, and formulate an optimal delivery plan.” Specifically, the disaster response prediction and simulation unit executes ensemble inference of a large language model based on a transformer architecture and a time-series prediction model. The system extracts long-term dependencies in input data using a self-attention mechanism. Input data to the AI model is a multidimensional time-series tensor indicating a transition of the number of evacuees during past disasters, and an environmental variable vector indicating current weather conditions. Furthermore, the system tokenizes a prompt described in natural language and inputs it to the AI model as an embedding vector. The AI model integrates these input data and performs non-linear transformation in a latent space. Output data from the AI model is a numerical matrix indicating a required amount of relief supplies for each hour for the next 72 hours at each evacuation shelter. In addition, the AI model outputs a probability distribution tensor indicating a certainty of prediction. When the certainty falls below a predetermined threshold, the processing unit activates a feedback loop requesting additional data collection. The system transfers the output numerical matrix to a subsequent relief supply delivery plan module. The system predicts a restoration time of transportation infrastructure using a long short-term memory network. Input data to the network is a one-hot encoding array of categorical variables indicating a degree of damage to bridges and roads. Output data from the network is an array of integer values indicating an estimated time until completion of restoration of each link. Through these processes, the system completely replaces conventional prediction methods that rely on human intuition and experience. The system mathematically unravels complex correlations among multiple variables. The system exhibits a technical effect of preventing excess or deficiency of relief supplies and optimally allocating limited resources.
Step 4: Automatic Generation of Relief Supply Delivery Plan An optimal relief supply delivery plan is automatically generated based on relief supply demand predicted by the generative AI, inventory at each base, road conditions, and operation statuses of transportation means such as trucks, helicopters, and drones. For example, when 5000 liters of water, 200 blankets, and 100 sets of medicines are in short supply at an evacuation shelter in City A, necessary relief supplies are aggregated from a nearest relief supply base or a stockpile warehouse of another local government, a passable road is selected, and a truck is arranged. When a major road is severed, an alternative route is searched for, and air transportation by a helicopter or a drone is combined as necessary. Delivery to a plurality of evacuation shelters is simultaneously optimized, and a delivery route and order, a required number of vehicles, an estimated time of arrival, a loading plan, driver assignment, a refueling plan, and the like are automatically calculated. When a truck being delivered encounters traffic congestion or a road closure, a route is recalculated in real time and related parties are notified. Specific examples of prompt sentences to be read into the generative AI include “Automatically generate an optimal delivery route and delivery means based on the latest relief supply demand prediction of each evacuation shelter and road conditions” and “Formulate a simultaneous delivery plan to a plurality of evacuation shelters at a minimum cost, and calculate a required number of vehicles and an estimated time of arrival.” Specifically, the relief supply delivery plan generation unit solves a combinatorial optimization problem using a deep reinforcement learning algorithm. The system constructs a multi-agent reinforcement learning environment that defines delivery vehicles and drones as autonomous agents. Input data to the AI model is a request vector indicating a relief supply demand amount of each evacuation shelter, a state tensor indicating a current position and a loadable amount of each vehicle, and an adjacency matrix indicating a transit cost of a road network. The AI model executes a policy gradient method based on a Markov decision process. Output data from the AI model is an index array of nodes to be visited next by each vehicle, and a floating-point matrix indicating an unloading amount at each node. The processing unit generates a sequence of GPS coordinates indicating a specific travel route of each vehicle based on the output data. The system transmits the generated route information to an in-vehicle terminal of each vehicle via a wireless communication network. When receiving new road closure information while the vehicle is traveling, the system immediately updates a reward function and triggers a re-learning process. Output data from the re-learning process is a node sequence of a dynamically modified detour route. The system push-notifies the in-vehicle terminal of the detour route in real time. Through these processes, the system derives a sub-optimal solution within a practical calculation time for NP-hard problems such as a traveling salesperson problem and a delivery planning problem. The system minimizes delivery delays while suppressing consumption of calculation resources. The system brings about a technical effect of realizing reliable and efficient relief supply transportation even under confused traffic conditions during a disaster.
Step 5: Information Sharing and Visualization Information such as relief supply needs, inventory statuses, delivery plans, and transportation progress for each evacuation shelter generated on the server side is distributed in real time to a dashboard screen or a map display screen on the terminal side. A relief supply shortage status of evacuation shelters nationwide, a current position of a truck being delivered, an estimated time of arrival, a transition of the number of evacuees for each evacuation shelter, a relief supply consumption pattern, an operation status of transportation infrastructure, the number of acceptable patients at medical institutions, an occurrence status of isolated settlements, and the like are visualized on a map. Related parties can immediately grasp the situation from a terminal and make decisions such as additional arrangement and route change as necessary. A relief supply consumption pace and a remaining inventory amount of each evacuation shelter are displayed in a graph on the dashboard, and future shortage predictions and replenishment timings are visualized. When a field person in charge inputs information from a terminal, the generative AI immediately predicts new relief supply demand on the server side, automatically updates a delivery plan, and notifies terminals of related parties. Specifically, the information sharing and visualization unit executes an algorithm for optimizing data streaming processing to a front-end terminal. The system establishes a bidirectional and low-latency communication channel between a server and a client using a WebSocket protocol. The processing unit dynamically extracts only data included in a user's display area using a spatial index structure. Input data to the processing unit is a difference data stream in JSON format indicating a state update of the entire system. The processing unit calculates geometry information necessary for drawing from the difference data. Output data from the processing unit is a vertex coordinate array for drawing a polygon on a map, and a rendering attribute vector specifying a color and transparency of each object. The system directly transfers these output data to a graphics processing unit of a client terminal. The terminal executes redrawing of a screen at high speed using hardware acceleration. When receiving new text input or numerical data from a field terminal, the system immediately activates a natural language processing model. Output data from the model is a score value indicating a degree of urgency of input content. When the score value exceeds a predetermined threshold, the system sets a flag variable for blinking a corresponding icon on the screen to true. Through these processes, the system minimizes consumption of network bandwidth. The system completely prevents a decrease in frame rate even when displaying tens of thousands of dynamic objects simultaneously. The system exhibits a technical effect of reducing a user's cognitive load due to information overload and enabling intuitive situation grasping.
Step 6: Model Evolution by Federated Learning Actual disaster response data and new event data are continuously learned by federated learning on the server side to evolve simulation accuracy and a prediction model of the generative AI. For example, the AI learns a relief supply amount actually required, a required delivery time, movements of evacuees, acceptance statuses of medical institutions, a restoration speed of communication infrastructure, and the like in the current disaster, enabling highly accurate prediction and planning in subsequent disasters. The AI learns region-specific characteristics, such as an increase in demand for heating appliances and winter clothing in heavy snowfall areas in winter, a tendency for delivery delays due to traffic congestion to occur in urban areas, a tendency for isolated settlements to occur in mountainous areas, and an increase in demand for avoidance of crowding in evacuation shelters and sanitary goods during an infectious disease epidemic, and automatically generates an optimal plan considering these in the next disaster. Specific examples of prompt sentences to be read into the generative AI include “Integrate past actual disaster response data and new event data, and update a relief supply demand prediction model for the next disaster” and “Generate a disaster response simulation model reflecting region-specific characteristics and past lessons.” Specifically, the federated learning evolution unit executes a federated averaging algorithm in a distributed computing environment. The system causes a local server of each local government or base to function as an edge node. The edge node re-learns a local neural network model using raw data collected at its own base. Input data in the learning process is an error tensor indicating a difference between a predicted relief supply demand amount and an actual consumption amount. The edge node updates weight parameters using a stochastic gradient descent method. Output data from the edge node is a gradient matrix indicating a difference in the updated weight parameters. The system encrypts and transmits only the gradient matrix to a central server without transmitting raw data to the outside. The central server updates a global model by performing a weighted average of gradient matrices received from a large number of edge nodes. Output data from the central server is a weight tensor of an optimized new global model. The system broadcasts the weight tensor to all edge nodes, and updates an inference engine of each node by hot swapping. The system uses a meta-learning algorithm in combination to perform domain adaptation for each region. Input data to the algorithm is an environmental variable vector indicating climatic conditions and population dynamics of each region. Output data from the algorithm is a parameter array for region-specific fine-tuning. Through these processes, the system completely protects the privacy of personal information and confidential data. The system dramatically reduces a load on a communication network. The system brings about a technical effect of continuously improving generalization performance of a model for unknown disaster patterns and suppressing overfitting.

### Specific Use Case

For example, assume a case where a large-scale earthquake occurs in a wide-area local government area including a coastal area, and enormous damage is assumed across a plurality of municipalities. In this case, the data collection and integration unit collects, in real time, various information such as the number of evacuees and attribute information from an evacuation shelter entry/exit management system of each local government, a relief supply inventory amount from a stockpile warehouse management system, closed sections and bridge damage information from a road management system, railway and bus operation statuses from transportation operators, bed operation statuses from medical institutions, truck operation statuses from logistics operators, aftershock and tsunami warnings from meteorological observation organizations, communication infrastructure operation statuses from communication operators, current statuses of evacuation shelters and relief supply shortage reports input by field personnel using terminals, and further image data of a disaster-stricken area from drones and surveillance cameras, and integrates them on the server side. Based on these data, the digital twin generation and update unit reproduces map data of a geographic information system, 3D models of buildings, population distribution, location information of evacuation shelters, medical institutions, and logistics bases, and operation statuses of critical infrastructure in a virtual space, and immediately reflects building collapse, road severance, occurrence of isolated settlements, evacuation shelter capacities, the number of acceptable patients at medical institutions, operation statuses of logistics bases, and the like due to the earthquake. Specifically, the system activates a massively parallel data processing pipeline peculiar to a wide-area disaster. The data collection and integration unit buffers data packets arriving asynchronously from millions of endpoints using a message queuing system. The processing unit analyzes aerial images from drones in real time using a convolutional neural network. Input data to the network is a multispectral image tensor with a resolution of 4096×2160. The network executes convolution operations of edge detection and feature extraction. Output data from the network is a bounding box coordinate array of collapsed buildings and severed roads, and a probability score from 0 to 1 indicating a severity of damage. When the probability score exceeds a predetermined threshold, the system assigns a damage flag to the coordinates. The digital twin generation and update unit receives an integrated state vector including the damage flag. The processing unit searches and updates 3D objects in the virtual space at high speed using a spatial hash algorithm. Input data to the processing unit is a GPS coordinate vector to which the damage flag is assigned. Output data from the processing unit is a vertex displacement matrix for deforming a polygon mesh of a corresponding object in the virtual space. The system applies the matrix to a rendering engine, and immediately generates a destruction expression based on a physical simulation. Through these processes, the system processes massive damage information over a wide area without delay. The system optimizes memory usage of a computer and completely prevents a system crash. The system exhibits a technical effect of synchronizing physical changes in the real world to the virtual space with millisecond accuracy.

The disaster response prediction and simulation unit uses the generative AI as an essential component, learns past earthquake disaster data, a transition of the number of evacuees for each evacuation shelter, a relief supply consumption pattern, damage statuses of roads and railways, operation histories of medical institutions, delivery records of logistics bases, and the like, and automatically calculates, also in the current disaster, a transition of the number of evacuees for the next few hours to a few days and quantities of necessary food, water, blankets, medicines, sanitary goods, winter clothing, generators, fuel, communication equipment, and the like for each evacuation shelter. For example, the AI predicts that the proportion of elderly people and infants is high in evacuation shelters in coastal areas, and the demand for medicines, milk, disposable diapers, and nursing care products stands out, and automatically determines that isolated settlements are likely to occur in mountainous areas, and air transportation by helicopters or drones is required. When major roads are severed, the AI searches for alternative routes, optimizes simultaneous delivery to a plurality of evacuation shelters, and automatically calculates a delivery route and order, a required number of vehicles, an estimated time of arrival, a loading plan, driver assignment, a refueling plan, and the like. Furthermore, during an infectious disease epidemic, the AI also predicts avoidance of crowding in evacuation shelters and an increase in demand for sanitary goods, and preferentially arranges necessary relief supplies. Specifically, the disaster response prediction and simulation unit executes a graph attention network in order to resolve complex dependencies in a wide-area space. The system applies a self-attention mechanism to a graph structure having each evacuation shelter and logistics base as a node, and dynamically calculates the degree of influence between nodes. Input data to the AI model is an attribute vector indicating population dynamics of each evacuation shelter, and an adjacency matrix tensor indicating a damage probability of surrounding roads. The AI model extracts a feature representation of a hidden layer from the input data. Output data from the AI model is a time-series tensor of a predicted demand amount value in each relief supply category, and a probability score indicating an isolation risk of each node. When the isolation risk score exceeds a predetermined threshold, the processing unit executes a branching process of automatically activating an air transportation arrangement module. The system solves a routing problem of a plurality of vehicles using a genetic algorithm. Input data to the algorithm is the predicted demand amount value tensor and an initial state vector of each vehicle. The algorithm iteratively applies crossover and mutation operators to evolve a solution population. Output data from the algorithm is a node sequence of an optimized delivery route, and a floating-point array indicating an estimated time of arrival of each vehicle. The system writes the output data to a subsequent vehicle allocation management database. Through these processes, the system derives a global optimal solution for the entire wide area without falling into local optimization. The system realizes efficient allocation of computational resources. The system brings about a technical effect of preventing the occurrence of chain relief supply shortages and traffic congestion.

The information sharing and visualization unit distributes, in real time, relief supply needs, inventory statuses, delivery plans, transportation progress, a transition of the number of evacuees, occurrence statuses of isolated settlements, the number of acceptable patients at medical institutions, operation statuses of transportation infrastructure, and the like for each evacuation shelter generated on the server side to a dashboard screen or a map display screen on the terminal side, and related parties can immediately grasp a situation from a terminal and make a decision such as additional arrangement or route change as necessary. When an on-site person in charge inputs an increase in the number of people in an evacuation shelter or a relief supply shortage from a terminal, the generative AI immediately predicts new relief supply demand on the server side, automatically updates a delivery plan, and notifies terminals of related parties. On the dashboard, a relief supply consumption pace and a remaining inventory amount of each evacuation shelter are displayed in a graph, and future shortage predictions and replenishment timings are also visualized. Specifically, the information sharing and visualization unit executes dynamic data binding and a differential update algorithm to minimize a drawing load on a client terminal. The system maintains a state management tree on the server side and extracts only changed nodes. Input data to the processing unit is a natural language vector of text transmitted from an on-site terminal, and an array of numerical data. The processing unit inputs the input data to a natural language processing model in real time. Output data from the model is a score value indicating an urgency level of input content, and a category classification label. The system rearranges a priority queue of payloads to be transmitted to clients based on the score value. Output data from the processing unit is a serialized differential packet in JSON format. The system multicasts the differential packet to all corresponding terminals using a publish-subscribe model. A rendering engine on the terminal side analyzes the received differential packet. Output data from the engine is a control point coordinate array of a Bezier curve for drawing a graph on a screen. When the urgency score exceeds a predetermined threshold, the system highlights a corresponding area on the screen and fires a forced push notification. Through these processes, the system eliminates unnecessary full-screen redrawing and dramatically reduces battery consumption and CPU usage of the terminal. The system exhibits a technical effect of completely guaranteeing immediacy and consistency of information even in a disaster environment where a communication band is limited.

The federated learning evolution unit allows the AI to learn an amount of relief supplies actually required in the current disaster, a required delivery time, movements of evacuees, acceptance statuses of medical institutions, a restoration speed of communication infrastructure, and the like, enabling highly accurate prediction and planning in subsequent disasters. For example, the AI learns region-specific characteristics such as an increase in demand for heating appliances and winter clothing in heavy snowfall areas in winter, a tendency for delivery delays due to traffic congestion to occur in urban areas, a tendency for isolated settlements to occur in mountainous areas, and an increase in demand for avoidance of crowding in evacuation shelters and sanitary goods during an infectious disease epidemic, and automatically generates an optimal plan considering these in the next disaster. Specifically, the federated learning evolution unit executes a domain adaptation algorithm for correcting a bias in data distribution for each region. The system runs an independent learning process in the background on a local server in each region. Input data to the learning process is an error tensor indicating a difference between an estimated value of a required delivery time output by a prediction model and an actual required time obtained from a GPS log. The process fine-tunes weights of a local model using a backpropagation method. Output data from the process is a weight update matrix that has learned a region-specific bias. The system transmits the weight update matrix to a central server. The central server executes a weighted averaging process based on regional similarity on the weight update matrix from each region. Input data to the process is an environmental feature vector indicating a population density and an elevation variance of each region. Output data from the process is a parameter tensor of a base model shared by all regions, and a parameter array of an adapter module dedicated to each region. The system dynamically combines these two parameters when executing inference. Through these processes, the system completely prevents an overfitting phenomenon of excessively adapting to specific regional data. The system enables zero-shot learning that transfers learning results of urban areas even to depopulated areas where data collection is difficult. The system brings about a technical effect of continuously and autonomously improving prediction accuracy of the entire system.

Specific examples of prompt sentences to be read by the generative AI include “Predict a required amount of relief supplies and an optimal delivery route for each evacuation shelter for the next 24 hours based on the latest evacuation shelter entry/exit data, relief supply inventory data, road traffic status data, and medical institution operation status data,” “Simulate a transition of the number of evacuees and a change in relief supply demand for the next 72 hours based on earthquake disaster data for the past 10 years, a current population distribution in a disaster-stricken area, an operation status of transportation infrastructure, and an operation status of logistics bases,”

“Predict quantities of necessary medicines, milk, disposable diapers, and nursing care products when there are many elderly people and infants in an evacuation shelter in a coastal area, and formulate an optimal delivery plan,” “Formulate an optimal relief supply delivery plan including air transportation by helicopters or drones when an isolated settlement occurs,” and “Create a list of relief supplies to be preferentially arranged and a delivery plan in consideration of an increase in demand for sanitary goods in evacuation shelters during an infectious disease epidemic.” Specifically, the generative AI prompt management unit includes an algorithm that automatically executes dynamic prompt engineering. The system selects an optimal prompt template from a database triggered by a user input or a system state change. Input data to the processing unit is a multidimensional vector indicating a current system state, and an integer ID indicating a user request category. The processing unit executes a character string replacement process of embedding real-time numerical data or text data into a variable placeholder in the selected template. Output data from the processing unit is a token array of a context-optimized prompt. The system transfers the token array to an input layer of a large language model. The model executes autoregressive inference based on the input token array. Output data from the model is a natural language text indicating a prediction result or a plan proposal, and a structured data object in JSON format. The processing unit executes schema validation on the output JSON data. When detecting a missing essential field or a data type mismatch, the processing unit executes a loop process of automatically generating a prompt for error correction and requesting re-inference. Through these processes, the system physically suppresses hallucinations peculiar to large language models. The system completely guarantees consistency of a format of an inference result. The system exhibits a technical effect that a subsequent system module can safely and reliably parse an output of the AI.

As described above, the system of the present invention collects and integrates various data in real time immediately after a disaster occurs, reproduces the real world with high accuracy on a digital twin, predicts and simulates, with high accuracy, a transition of the number of evacuees and relief supply demand for each evacuation shelter, an operation status of transportation infrastructure, and an optimal relief supply delivery plan using the generative AI as an essential component, visualizes and shares information, and evolves a model by federated learning, thereby becoming a unique social infrastructure that realizes prompt and accurate support for disaster victims without depending on conventional manual work or personal judgment. Specifically, the system realizes a fundamental improvement of computer technology itself through cooperative operations of the respective modules described above. The system adopts a microservices architecture in a distributed computing environment. The system asynchronizes inference processing of each AI model, and executes task load balancing via a message queuing system. Input data to the orchestration module is a network traffic log of the entire system, and a resource tensor indicating CPU and memory usage of each container. The module predicts a future load spike based on the input data. Output data from the module is a control command instructing scale-out of a specific inference container, and a resource allocation matrix. The system dynamically provisions a virtual machine based on the control command. Through these processes, the system completely eliminates a single point of failure and dramatically improves fault tolerance of the entire system. The system ensures scalability even against sudden access concentration during a disaster, and provides a complete guarantee of real-time processing. The system brings about a technical effect of realizing optimization of hardware resources and pursuit of computational efficiency to the limit, beyond mere business automation.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a configuration and an operation of a city operation optimization AI system using a real-time digital twin of a whole city will be described in detail extremely specifically and comprehensively. Specifically, the system adopts a massively parallel distributed processing architecture for processing a huge data stream on a city scale. The architecture has a hierarchical structure of an edge computing layer and a cloud computing layer. The system executes a lightweight data filtering algorithm on each edge device. Input data to the edge layer is a raw data stream generated in milliseconds from millions of IoT sensors in a city. The edge layer applies noise removal and downsampling processing to the raw data. Output data from the edge layer is a normalized and compressed feature vector. The system transmits only the feature vector to the cloud layer. The cloud layer routes the received vector to each specialized AI module. Through these processes, the system dramatically reduces consumption of a communication band to the cloud side. The system exhibits a technical effect of minimizing latency of data processing and enabling real-time state grasping of the whole city.

The system is composed of a city data collection and integration unit, a city digital twin generation and update unit, a city operation optimization unit, an information sharing and visualization unit, a federated learning evolution unit, an on-site input support unit, an alert notification unit, a generative AI prompt management unit, and the like. Specifically, each component of the system communicates with each other via a high-speed internal bus and a shared memory space. The system includes a directed acyclic graph-based task scheduler that manages data dependencies between modules. Input data to the scheduler is an event signal indicating completion of processing of each module, and a pointer to a memory address where output data is stored. The scheduler executes a topological sort algorithm to identify a next executable task. Output data from the scheduler is an activation signal of a module to be executed next, and a resource allocation parameter to a thread pool. The system triggers tensor operations on a GPU cluster in parallel based on the output data. Through these processes, the system completely eliminates a bottleneck caused by a waiting time between modules. The system brings about a technical effect of maximizing an operation rate of hardware and improving throughput of the entire system to the limit.

The city data collection and integration unit collects and integrates, in real time, various data from all sensors and systems in a city. For example, the unit acquires the number of vehicles, an average speed, and a traffic volume by vehicle type from traffic volume sensors installed on major arterial roads and intersections, and comprehensively collects all data related to city activities, such as operation statuses and delay information of buses, railways, subways, and streetcars from an operation management system of public transportation, switching timings and failure information of traffic lights from a traffic light control system, availability and utilization rates from a parking lot management system, consumption amounts of electricity, gas, and water of each home, building, and factory, and operation statuses of solar power generation and storage batteries from an energy management system, temperature, humidity, precipitation, wind speed, and solar radiation amount from a meteorological observation system, air quality (PM2.5, NOx, CO2), noise, vibration, positions and collection statuses of garbage trucks from environmental sensors, movement histories from smartphones and transportation IC cards of residents, resident service usage histories, administrative procedure histories, event holding information, disaster occurrence information (earthquake, typhoon, heavy rain, tsunami, fire, power outage, communication failure), infrastructure operation statuses (water and sewage, electricity, communication, roads, bridges, tunnels, railways, airports, ports), disaster, congestion, and infrastructure abnormality report data from SNS and reporting applications, operation statuses of IoT home appliances, operation statuses of medical institutions (number of beds, emergency transport acceptance statuses, medicine inventory), attendance information and school safety information of educational institutions, and operation statuses of logistics bases and location information of delivery vehicles. These data are aggregated to a server by various means such as API linkage, IoT sensors, data linkage with existing business systems, manual input from a terminal by an on-site person in charge, automatic collection by image recognition and voice recognition, and automatic analysis of image and video data by drones and surveillance cameras, and are integrated after being subjected to encryption and anonymization processing. For example, when an event is held, a congestion status is grasped by combining person flow sensors and posted data from SNS, and an optimal collection route is automatically generated by integrating real-time positions of garbage trucks and full sensor information of garbage cans. For example, on extremely hot days, power consumption data of each building and home is aggregated and utilized for predicting peak power and transmitting a power saving alert. For example, during heavy rain, river water level sensors, road flooding sensors, evacuation shelter capacity statuses, and road flooding information are immediately collected and utilized for disaster response. Specifically, the city data collection and integration unit executes a process of embedding a multimodal data stream into a common high-dimensional vector space. The processing unit operates a one-dimensional convolutional neural network for time-series data and a vision transformer for image data in parallel. Input data to the processing unit is, for example, an RGB image tensor with a resolution of 1920×1080 from an intersection camera, and a floating-point array of temperature, humidity, and PM2.5 concentration from an environmental sensor. The processing unit applies an independent feature extraction pipeline to the input data. Output data from the processing unit is a 512-dimensional feature vector extracted from each data source. The system integrates these feature vectors in a concatenation layer to generate a single integrated state tensor representing a current state of the city. The system transfers the integrated state tensor to a subsequent digital twin generation module. The system executes irreversible anonymization processing using locality-sensitive hashing at a hardware level for data including personal information. Through these processes, the system mathematically extracts semantic relevance of heterogeneous data. The system exhibits a technical effect of standardizing an input dimension of a subsequent prediction model and dramatically improving computational efficiency.

The city digital twin generation and update unit reproduces buildings, roads, traffic, energy infrastructure, environment, resident activities, infrastructure operation statuses, logistics bases, medical institutions, educational institutions, event venues, and the like in a virtual space with high accuracy on a whole city and each area basis using the wide variety of data obtained from the city data collection and integration unit, and updates a state of the city in real time. For example, the unit integrates map data acquired from a geographic information system, 3D models of buildings, road networks, topographical data of rivers and mountains, location information of evacuation shelters, medical institutions, and logistics bases, population distribution data, operation statuses of critical infrastructure, and the like, and faithfully reproduces a city structure and activities in the real world. When a disaster occurs, the unit simulates an influence range of an earthquake, flood, landslide disaster, tsunami, fire, power outage, large-scale communication failure, or the like, and immediately reflects a damage assumption, an impassable section, an isolated region, the number of accommodatable people in an evacuation shelter, the number of acceptable patients at a medical institution, an operation status of a logistics base, and the like on the digital twin. For example, when an earthquake occurs, the unit reproduces a building collapse risk, road severance, bridge damage, and a suspended section of a railway in the virtual space, and immediately visualizes which area of the city will be isolated. For example, when an event is held, the unit reproduces changes in person flow and traffic volume around a venue and a congestion status of public transportation in real time, and simulates an effect of a congestion mitigation measure. For example, during snowfall in winter, the unit reflects an operation status of snowplows and snow depth data, and visualizes a traffic obstacle and a logistics delay risk. Specifically, the city digital twin generation and update unit models a physical and logical structure of the city using a dynamic graph neural network. The network constructs a large-scale graph having intersections and buildings as nodes and roads and communication networks as edges. Input data to the network is the integrated state tensor and a multidimensional vector indicating a static attribute of each node and edge. The network executes a message passing algorithm incorporating a time decay function, and calculates an amount of change from a past state. Output data from the network is a tensor indicating a congestion degree score of each node, a traffic flow prediction value of each edge, and a damage probability distribution during a disaster. The processing unit updates a dynamic rendering parameter of a 3D object in the virtual space based on these output tensors. The system transfers the updated parameter to a graphics pipeline, and executes recalculation of a texture and geometry. Through these processes, the system mathematically expresses complex interactions of the city. The system brings about a technical effect of reducing a calculation order of simulation and completely ensuring real-time performance.

The city operation optimization unit uses the generative AI as an essential component, analyzes data on the city digital twin, and realizes optimization of city operation and automatic response in the event of a disaster. For example, in a traffic field, the generative AI analyzes traffic volume data, public transportation operation statuses, traffic light states, parking lot availability, resident movement histories, event holding information, and the like, predicts a future traffic congestion occurrence risk, and simulates, proposes, and executes, in real time, optimization of traffic light control, increase in public transportation services, proposal of detour routes, automatic issuance of traffic regulations, and the like. For example, when traffic congestion is predicted at a major intersection during morning and evening rush hours, the unit automatically adjusts a switching timing of a traffic light, proposes an increase in bus and railway services, and notifies residents of an optimal movement route. For example, when congestion on surrounding roads is predicted when an event is held, the unit automatically notifies operation of extra flights of public transportation and recommendation of park-and-ride. In an energy field, the generative AI analyzes consumption data of electricity, gas, and water of each home and building, operation statuses of solar power generation and storage batteries, meteorological data, and the like, predicts an increase in consumption due to a future temperature rise or event holding, and automatically transmits a power saving alert for demand suppression and an instruction to utilize distributed power generation in order to optimize a power supply and demand balance at a peak time. For example, the unit identifies an area where power supply and demand are tight on an extremely hot day, and notifies residents and business operators of utilization of distributed power generation and a power saving alert.

For example, during a power outage, the unit performs preferential power supply to critical infrastructure and automatic arrangement of generators. In an environmental field, the generative AI analyzes air quality sensors, noise sensors, temperature and humidity sensors, garbage collection statuses, CO2 absorption amounts of green spaces, and the like, predicts an increase in PM2.5 and noise, and automatically proposes and executes measures such as traffic regulations, promotion of greening, and optimization of garbage collection routes. For example, when there is a sign that air quality will deteriorate in an industrial area, the unit proposes traffic regulations and adjustment of factory operation. For example, the AI optimizes a route of a garbage truck, and minimizes fuel consumption and CO2 emissions. In disaster response, the generative AI analyzes disaster occurrence information such as earthquakes, heavy rains, and typhoons, evacuation shelter capacity statuses, infrastructure damage statuses, resident location information, report data from SNS, and the like, and automatically formulates and executes damage expansion prediction, evacuation guidance, prioritization of infrastructure restoration, a relief supply delivery plan, and the like. For example, immediately after an earthquake occurs, the unit formulates an area with a high isolation risk and a preferential evacuation guidance and relief supply delivery plan based on building damage data, evacuation shelter capacity statuses, and road severance information. For example, during heavy rain, the unit identifies an area with a high river flooding risk, and automatically notifies residents of an evacuation instruction.

In resident services, the generative AI automatically proposes and notifies individually optimal administrative services, health advice, event guidance, individual evacuation instructions during a disaster, and the like based on resident attributes, behavior histories, health data, event participation histories, administrative procedure histories, and the like. For example, the unit automatically transmits individual evacuation instructions and health management advice to elderly people and people requiring consideration. For example, the unit automatically guides child-rearing households on availability of childcare facilities and vaccination schedules. Specifically, the city operation optimization unit executes a hybrid inference engine combining a deep reinforcement learning algorithm and a large language model. The engine constructs a multi-agent reinforcement learning environment that treats each sector of the city as an autonomous agent. Input data to the engine is a state vector of each area extracted from the digital twin, and a tensor indicating a past measure history. The engine simultaneously optimizes an action-value function and a policy function of each agent using an actor-critic method. Output data from the engine is numerical data indicating an optimal green time extension seconds of a traffic light, a matrix indicating an output adjustment amount of a distributed power source, and a natural language token array constituting an alert text for residents. The processing unit directly transmits the output control parameter to an API endpoint of each infrastructure control system. The processing unit transfers the alert text to a push notification distribution server. Through these processes, the system autonomously resolves a trade-off between a plurality of conflicting optimization goals such as congestion mitigation and energy saving. The system exhibits a technical effect of realizing multivariable simultaneous optimization impossible for humans and improving operation efficiency of the whole city to the limit.

The information sharing and visualization unit visualizes and shares, in real time, a state of the city, predictions, optimization proposals, response plans in the event of a disaster, and the like with related parties such as city operators, infrastructure operators, and residents via a dashboard or a notification. For example, traffic conditions of the whole city, energy supply and demand, environmental indicators, damage statuses when a disaster occurs, capacity statuses of evacuation shelters, infrastructure restoration progress, and the like are visualized on a map or a graph to enable related parties to immediately grasp a situation. For example, an optimal movement route, a power saving alert, and an evacuation instruction in the event of a disaster are notified to residents via a smartphone application, and risks of the whole city and optimization proposals are displayed in a list on a dashboard for city operators. For example, an optimization result of a delivery route and traffic obstacle information are notified in real time to logistics operators. Specifically, the information sharing and visualization unit executes an adaptive data filtering process according to a user's authority and current position. The processing unit extracts only data within a user's region of interest at high speed using a spatial index structure. Input data to the processing unit is a GPS coordinate vector indicating the user's current position and an alert information tensor of the entire system. The processing unit applies a geometric intersection determination algorithm to the input data. Output data from the processing unit is structured data in a JSON format in which only alerts related to the user are extracted, and a polygon vertex array for map drawing. The system push-distributes the extracted data to a client terminal. The terminal executes a drawing process using hardware acceleration based on the received data. Through these processes, the system significantly reduces memory consumption of the client terminal. The system brings about a technical effect of optimizing a network bandwidth and preventing a decrease in a drawing frame rate.

The federated learning evolution unit continuously learns actual city operation data and new event data by federated learning to evolve a prediction and optimization model of the generative AI. For example, the AI learns past actual disaster response data, effects of traffic congestion mitigation measures, actual energy supply and demand adjustment data, effects of environmental measures, usage statuses of resident services, and the like, enabling highly accurate prediction and optimization in subsequent city operations and disaster responses. For example, region-specific characteristics are learned, such as an increase in demand for heating appliances and winter clothing in heavy snowfall areas in winter, a tendency for delivery delays due to traffic congestion in urban areas, a tendency for isolated settlements to occur in mountainous areas, and an increase in demand for avoiding crowding in evacuation shelters and sanitary goods during an infectious disease epidemic, and an optimal plan considering these is automatically generated in the next disaster. Specifically, the federated learning evolution unit executes gradient calculation of a local model on an edge server in each city area, and applies a federated averaging algorithm that aggregates them on a central server. The algorithm learns various patterns of the whole city while protecting data privacy. Input data to the edge server is a time-series tensor indicating actual traffic volume and energy consumption observed in each area. The edge server executes error backpropagation of the local model using the data. Output data from the edge server is a weight update difference tensor of the local model. The system transmits only the difference tensor to the central server. Output data from the central server is a new weight parameter matrix of an aggregated and averaged global model. The system redistributes the updated global model to each edge server, and updates an inference engine by hot swapping. Through these processes, the system eliminates network transfer of raw data and dramatically reduces a communication load. The system exhibits a technical effect of constructing a model with high generalization performance that eliminates region-specific biases.

An on-site input support unit provides an interface for an on-site person in charge to input and upload a situation of an evacuation shelter, an inventory status of relief supplies, a damage status, photograph and voice data, and the like from a terminal, and transmits the input data to a server side. For example, the number and attributes of people in an evacuation shelter, types and quantities of required relief supplies, on-site photographs and videos, voice memos, detailed descriptions of damage statuses, and the like are input from a tablet terminal or a smartphone. For example, confirmation of receipt of relief supplies and a delivery completion report on site are performed from a terminal. For example, an on-site person in charge quickly registers information utilizing voice input and image recognition. Specifically, the on-site input support unit executes real-time data preprocessing and a compression algorithm using edge AI. The processing unit operates a lightweight convolutional neural network on a terminal in order to maximize the use of limited computational resources of a mobile terminal. Input data to the network is a high-resolution on-site image tensor acquired from a camera of the terminal and voice waveform data from a microphone. The network locally executes object detection in an image and text conversion processing of voice. Output data from the network is a bounding box coordinate array of a damaged part extracted from the image and a natural language vector of text converted from the voice. The system transmits only the lightweight feature amount data to the server side. The server immediately maps the received data to a digital twin. Through these processes, the system guarantees reliable data transmission even under an unstable communication environment during a disaster. The system brings about a technical effect of distributing a processing load on the server side to an edge side and improving a response speed of the entire system.

An alert notification unit notifies, in real time, terminals of related parties of alerts such as important information and abnormality detection from the generative AI and the entire system, a change in a delivery plan, a rapid increase in the number of people in an evacuation shelter, a prediction of a shortage of relief supplies, occurrence of a road closure, an acceptance restriction of a medical institution, and occurrence of a communication failure. For example, when the number of evacuees rapidly increases in an evacuation shelter, an alert for additional relief supply arrangement is transmitted. For example, when a truck being delivered encounters a road closure, an alert for a route change instruction is transmitted. For example, when an acceptance restriction of a medical institution occurs, a transportation instruction to a neighboring medical institution is notified. For example, when a communication failure occurs, an alert prompting use of an alternative communication means is transmitted. Specifically, the alert notification unit constantly monitors an abnormality score and a prediction probability distribution output from the generative AI. The alert notification unit immediately generates a hardware interrupt when the abnormality score exceeds a preset dynamic threshold. Triggered by the interrupt, the alert notification unit executes low-latency data transmission using a push notification protocol to mobile terminals of related parties. When generating notification content, the alert notification unit dynamically generates a natural language text according to a situation using a large language model. The large language model receives, as inputs, a time-series array of sensor data that triggered abnormality detection, a categorical variable indicating a type of abnormality, and a geographical coordinate vector of a target region. The large language model generates, as outputs, structured data including a numerical score indicating a degree of urgency, a list of recommended response actions, and a notification text for related parties. The alert notification unit executes QoS control for preferentially allocating a bandwidth of a communication network based on the urgency score included in the structured data. Through this process, the system achieves a technical effect of reliably transmitting extremely important alert information even under a communication congestion environment such as during a disaster. The alert notification unit monitors an arrival confirmation response of the transmitted alert. When a confirmation response is not obtained within a certain period of time, the alert notification unit automatically executes a retransmission process using an alternative communication path or a different communication protocol. This configuration realizes optimization of data transmission closely linked with a communication layer, rather than mere display of information. This technology dramatically improves certainty and responsiveness of information transmission in use cases such as an emergency response system during a wide-area disaster and an abnormality monitoring system of a large-scale plant.

A generative AI prompt management unit manages prompt sentences necessary when utilizing the generative AI in the entire system, and provides an optimal prompt sentence to the generative AI according to a situation. For example, prompt sentences for predicting relief supply demand for each evacuation shelter and formulating a delivery plan, prompt sentences for a simulation instruction combining past disaster data and a current situation, prompt sentences for an automatic response to an inquiry from an on-site person in charge, prompt sentences for an automatic generation instruction of a disaster response manual, and the like are managed and provided to the generative AI as necessary. Examples include “Predict required amounts of relief supplies and optimal delivery routes for each evacuation shelter for the next 24 hours based on the latest evacuation shelter entry/exit data, relief supply inventory data, and road traffic status data,” “When there are many elderly people and infants in an evacuation shelter in City A, predict quantities of required medicines, milk, disposable diapers, and nursing care products, and formulate an optimal delivery plan,” “Simulate a transition of the number of evacuees and a change in relief supply demand for the next 72 hours based on earthquake disaster data for the past 10 years, a current population distribution in a disaster-stricken area, and an operation status of transportation infrastructure,” and “Analyze a damage report photograph from a site, extract collapsed buildings and an inundation range, and summarize a damage status.” Specifically, the generative AI prompt management unit executes a dynamic prompt construction process according to a situation context. The generative AI prompt management unit holds a plurality of prompt templates as vector representations in a database. The generative AI prompt management unit generates a multidimensional state vector indicating a current system state. The multidimensional state vector includes elements obtained by quantifying a type of disaster, an elapsed time, a damage scale, and types of available data sources. The generative AI prompt management unit calculates a cosine similarity between the multidimensional state vector and the vector representations of the prompt templates. The generative AI prompt management unit selects a template with the highest similarity. The generative AI prompt management unit automatically embeds real-time sensor data and database search results into placeholders of the selected template. During the embedding process, the generative AI prompt management unit applies an importance-based text summarization algorithm so that the number of tokens of input data does not exceed a context window limit of the large language model. The generative AI prompt management unit inputs the constructed prompt to an inference engine of the large language model. The inference engine outputs a text stream including a prediction result and a draft plan based on the input prompt. The generative AI prompt management unit parses the output text stream and converts it into structured data processable by a subsequent system module. Through this process, unlike a conventional method in which a human manually inputs a prompt, the system realizes fully automated prompt optimization based on mechanical state determination. This configuration achieves a technical effect of improving inference accuracy of the large language model and preventing waste of computational resources due to an invalid prompt. This technology is applicable to an autonomous control system of a smart city, a dynamic optimization system of a complex supply chain, and the like.

As described above, the embodiment of the present invention becomes a unique social infrastructure that realizes continuous optimization and resilience improvement of the whole city by collecting and integrating various data in a city in real time, generating a highly accurate digital twin on a whole city and each area basis, realizing optimization of city operation and automatic response in the event of a disaster with generative AI as an essential component, visualizing and sharing information, and evolving a model by federated learning.

### System Configuration

The system according to the present embodiment comprises a city data collection and integration unit, a city digital twin generation and update unit, a city operation optimization unit, an information sharing and visualization unit, a federated learning evolution unit, an on-site input support unit, an alert notification unit, and a generative AI prompt management unit.

The city data collection and integration unit has a function of collecting various data from all sensors and systems in a city in real time and integrating them on a server. For example, the city data collection and integration unit comprehensively collects all data related to city activities, such as acquiring the number of vehicles, average speed, and traffic volume by vehicle type from traffic volume sensors installed on major arterial roads and intersections, acquiring operation statuses and delay information of buses, railways, subways, and trams from operation management systems of public transportation, acquiring signal switching timings and failure information from traffic light control systems, acquiring availability and utilization rates from parking lot management systems, acquiring power, gas, and water consumption of each home, building, and factory and operation statuses of solar power generation and storage batteries from energy management systems, acquiring temperature, humidity, precipitation, wind speed, and solar radiation from meteorological observation systems, acquiring air quality (PM2.5, NOx, CO2), noise, and vibration from environmental sensors, acquiring positions and collection statuses of garbage trucks, acquiring movement histories from smartphones and transportation IC cards of residents, resident service usage histories, administrative procedure histories, event holding information, disaster occurrence information (earthquake, typhoon, heavy rain, tsunami, fire, power outage, communication failure), infrastructure operation statuses (water and sewage, power, communication, road, bridge, tunnel, railway, airport, port), disaster, congestion, and infrastructure abnormality report data from SNS and reporting applications, operation statuses of IoT home appliances, operation statuses of medical institutions (number of beds, emergency transportation acceptance status, medicine inventory), attendance information and school safety information of educational institutions, operation statuses of logistics bases, and location information of delivery vehicles, aggregates them to the server by various means such as API linkage, IoT sensors, data linkage with existing business systems, manual input from terminals by on-site persons in charge, automatic collection by image recognition and voice recognition, and automatic analysis of image and video data by drones and surveillance cameras, and integrates them after performing encryption and anonymization processing. Specifically, the city data collection and integration unit executes a preprocessing pipeline that maps heterogeneous data streams to a unified multidimensional tensor space. The city data collection and integration unit temporarily buffers packet data asynchronously transmitted from each sensor using a distributed message queuing system. The city data collection and integration unit applies time stamp synchronization processing and spatial coordinate normalization processing to the buffered data. The city data collection and integration unit applies an interpolation algorithm using a Kalman filter or a long short-term memory network to a data stream including a missing value to generate continuous time-series data. The city data collection and integration unit applies an object detection model using a convolutional neural network to image and video data. The object detection model receives a high-resolution image tensor as an input. The object detection model outputs, as outputs, structured data including bounding box coordinates, a class label, and a reliability score of a detected object. The city data collection and integration unit applies a transformer-based natural language processing model to text data described in a natural language to extract a feature vector indicating emotional polarity and an event category. The city data collection and integration unit stores these various formats of data in a graph database having a common spatiotemporal index. Each node of the graph database represents a physical entity, and an edge represents an interaction or a physical distance between entities. Through this process, the system achieves a technical effect of converting enormous and unstructured city data into a structured format that can be efficiently calculated by a subsequent artificial intelligence model. This configuration realizes semantic integration of data in a high-dimensional space, rather than mere accumulation of data. This technology dramatically reduces latency of data processing in use cases such as an integrated monitoring platform of a smart city and a predictive maintenance system of wide-area infrastructure.

The city digital twin generation and update unit has a function of reproducing buildings, roads, traffic, energy infrastructure, environment, resident activities, infrastructure operation statuses, logistics bases, medical institutions, educational institutions, event venues, and the like in a virtual space with high accuracy on a whole city and each area basis using the wide variety of data obtained from the city data collection and integration unit, and updating a state of the city in real time. For example, map data acquired from a geographic information system, 3D models of buildings, road networks, topographical data of rivers and mountains, location information of evacuation shelters, medical institutions, and logistics bases, population distribution data, operation statuses of critical infrastructure, and the like are integrated to faithfully reproduce a city structure and activities in the real world. When a disaster occurs, an influence range of an earthquake, flood, landslide disaster, tsunami, fire, power outage, large-scale communication failure, or the like is simulated, and a damage assumption, an impassable section, an isolated region, a capacity of an evacuation shelter, the number of acceptable patients of a medical institution, an operation status of a logistics base, and the like are immediately reflected on the digital twin. For example, when an earthquake occurs, a collapse risk of a building, a road disruption, a bridge damage, and a suspended section of a railway are reproduced in a virtual space to immediately visualize which area of the city will be isolated. For example, when an event is held, changes in human flow and traffic volume around a venue and a congestion status of public transportation are reproduced in real time to simulate an effect of a congestion mitigation measure. For example, during snowfall in winter, an operation status of a snowplow and snow depth data are reflected to visualize a traffic obstacle and a logistics delay risk. For example, during a power outage, a restoration prospect of power infrastructure and a priority supply status to an important facility are reflected in a virtual space. Specifically, the city digital twin generation and update unit adopts a hybrid simulation architecture in which calculation of a physics engine and inference of a deep learning model are tightly coupled. The city digital twin generation and update unit converts static structure data of the city into a voxel grid representation, and allocates a physical attribute to each voxel in a three-dimensional space. The city digital twin generation and update unit maps dynamic sensor data onto the voxel grid in real time to construct a four-dimensional spatiotemporal tensor. The city digital twin generation and update unit executes a graph convolutional network in order to predict damage propagation when a disaster occurs. The graph convolutional network receives, as inputs, an adjacency matrix indicating a topology of an infrastructure network and a feature matrix indicating a current operation state of each node. The graph convolutional network outputs, as an output, a probability distribution that each node will fall into a malfunction at a specific time in the future. The city digital twin generation and update unit executes a large number of scenario simulations by a Monte Carlo method in parallel based on the probability distribution. The city digital twin generation and update unit aggregates simulation results and specifies an expected value of damage and a worst-case scenario. The city digital twin generation and update unit dynamically changes a rendering parameter of an object in the virtual space based on the specified scenario. Through this process, the system achieves a technical effect of imitating a complex interaction in the real world on a computer at high speed and with high accuracy. This configuration mathematically elucidates a mechanism of a cascading failure that is difficult to predict by human intuition or a simple rule base. This technology provides quantitative prediction data serving as a basis for decision-making in use cases such as a national-level disaster prevention simulator and a dynamic routing system of a large-scale transportation network.

The city operation optimization unit has a function of analyzing data on a city digital twin using generative AI as an essential component, and realizing optimization of city operation and automatic response in the event of a disaster. For example, in a traffic field, the generative AI analyzes traffic volume data, public transportation operation statuses, traffic light states, parking lot availability, resident movement histories, event holding information, and the like, predicts a future traffic congestion occurrence risk, and simulates, proposes, and executes, in real time, optimization of traffic light control, increase in public transportation services, proposal of detour routes, automatic issuance of traffic regulations, and the like. For example, when traffic congestion is predicted at a major intersection during morning and evening rush hours, the unit automatically adjusts a switching timing of traffic lights, proposes an increase in bus and railway services, and notifies residents of an optimal movement route. For example, when congestion on surrounding roads is predicted when an event is held, the unit automatically notifies operation of extra public transportation services and recommendation of park-and-ride. In an energy field, the generative AI analyzes power, gas, and water consumption data of each home and building, operation statuses of solar power generation and storage batteries, meteorological data, and the like, predicts an increase in consumption due to a future temperature rise or event holding, and automatically issues a power saving alert for suppressing demand and an instruction to utilize distributed power generation in order to optimize a power supply and demand balance at a peak time. For example, the unit identifies an area where power supply and demand are tight on a day of extreme heat, and notifies residents and business operators of utilization of distributed power generation and a power saving alert. For example, in the event of a power outage, the unit performs preferential power supply to critical infrastructure and automatic arrangement of a generator. In an environmental field, the generative AI analyzes air quality sensors, noise sensors, temperature/humidity sensors, garbage collection statuses, CO2 absorption amounts of green spaces, and the like, predicts an increase in PM2.5 and noise, and automatically proposes and executes measures such as traffic regulations, promotion of greening, and optimization of garbage collection routes. For example, when there is a sign that air quality will deteriorate in an industrial area, the unit proposes traffic regulations and operation adjustment of factories. For example, the AI optimizes a route of a garbage collection vehicle to minimize fuel consumption and CO2 emissions. In disaster response, the generative AI analyzes disaster occurrence information such as earthquakes, heavy rains, and typhoons, evacuation shelter capacity statuses, infrastructure damage statuses, resident location information, report data from SNS, and the like, and automatically formulates and executes damage expansion prediction, evacuation guidance, infrastructure restoration prioritization, a relief supply delivery plan, and the like. For example, immediately after an earthquake occurs, the unit formulates an area with a high isolation risk and a preferential evacuation guidance and relief supply delivery plan based on building damage data, evacuation shelter capacity statuses, and road disruption information. For example, in the event of heavy rain, the unit identifies an area with a high river flooding risk and automatically notifies residents of an evacuation instruction. In resident services, the generative AI automatically proposes and notifies individually optimal administrative services, health advice, event guidance, individual evacuation instructions in the event of a disaster, and the like based on resident attributes, behavior histories, health data, event participation histories, administrative procedure histories, and the like. For example, the unit automatically transmits individual evacuation instructions and health management advice to the elderly and people requiring special care. For example, the unit automatically guides child-rearing households on availability of childcare facilities and vaccination schedules. Specific examples of prompt sentences to be read by the generative AI include “Predict a traffic congestion occurrence risk for each major intersection for the next 30 minutes based on current traffic volume data, public transportation operation statuses, and event holding information, and propose optimal traffic mitigation measures such as traffic light control and bus service increase,” “Identify an area where a supply and demand balance will be tight in the next two hours based on current energy consumption data, weather forecasts, and event information, and formulate an optimal transmission plan for distributed power generation and power saving alerts,” and “Formulate an area with a high isolation risk and a preferential evacuation guidance and relief supply delivery plan based on building damage data, evacuation shelter capacity statuses, and road disruption information immediately after an earthquake occurs.” Specifically, the city operation optimization unit functions as an autonomous agent system integrating a deep reinforcement learning algorithm and a large language model. The city operation optimization unit acquires a multidimensional state vector extracted from the city digital twin as an observation value of an environment. The city operation optimization unit inputs the observation value to a policy network of a deep reinforcement learning model. The policy network receives, as an input, a continuous value vector including a vehicle queue length at each intersection, a frequency deviation of a power grid, and a capacity rate of an evacuation shelter. The policy network generates, as an output, an action vector including the number of seconds to extend a green light time of a traffic light, a discharge command value of a storage battery, and a destination node ID of a delivery vehicle. The city operation optimization unit inputs the generated action vector to the large language model, and causes the large language model to execute an inference process in natural language for verifying validity of the action. The large language model searches a database of past similar cases and evaluates secondary effects that the proposed action may cause. The city operation optimization unit transmits the action vector as an actual control command to a control device of each infrastructure only when an evaluation score from the large language model exceeds a predetermined threshold. The city operation optimization unit evaluates a change in the environment after execution of the control using a reward function, and updates a weight parameter of the policy network by a proximal policy optimization algorithm. By this processing, the system exerts a technical effect of globally optimizing a group of city subsystems that are complexly intertwined. This configuration breaks through a limit of individual optimization based on a rule of thumb by a human operator, and realizes continuous optimal solution search in a high-dimensional space by a computer. This technology dramatically improves energy efficiency and safety of the entire system in use cases such as a next-generation smart grid control system and a swarm control system for fully autonomous vehicles.

The information sharing and visualization unit has a function of visualizing and sharing, in real time, a state of the city, predictions, optimization proposals, response plans in the event of a disaster, and the like with related parties such as city operators, infrastructure operators, and residents via a dashboard or a notification. For example, the unit visualizes traffic conditions of the whole city, energy supply and demand, environmental indicators, damage statuses and evacuation shelter capacity statuses when a disaster occurs, infrastructure restoration progress, and the like on a map or a graph, and enables related parties to immediately grasp a situation. For example, the unit notifies residents of an optimal movement route, a power saving alert, and an evacuation instruction in the event of a disaster via a smartphone application, and displays a list of risks and optimization proposals for the whole city on a dashboard for city operators. For example, the unit notifies logistics operators of optimization results of delivery routes and traffic obstacle information in real time. For example, the unit visualizes emergency transport acceptance statuses and medicine inventory statuses for medical institutions, and supports regional medical cooperation. Specifically, the information sharing and visualization unit includes a rendering engine that dynamically dimensionally compresses a huge amount of multidimensional data in accordance with human cognitive limits and generates an optimal visual representation. The information sharing and visualization unit calculates a priority of information to be displayed in accordance with a user's role and a current context. The information sharing and visualization unit applies a visualization technology of fluid simulation using a heat map generation algorithm or a particle system in order to highlight information with a high priority. The information sharing and visualization unit draws node and edge information acquired from a back-end graph database on a browser at high speed by hardware acceleration. The information sharing and visualization unit automatically generates a natural language summary text explaining a trend or an abnormal value of a complex data chart using a large language model. The large language model receives, as an input, a statistical feature amount of time-series data, an alert flag from an anomaly detection model, and profile information indicating a user's expertise level. The large language model generates, as an output, an explanatory text in which a difficulty level of technical terms is adjusted, or a bulleted list of actions to be taken next. The information sharing and visualization unit integrates the generated text and visual elements, and constructs an interactive dashboard interface. By this processing, the system exerts a technical effect of reducing a user's cognitive load due to information overload and supporting prompt and accurate decision-making. This configuration realizes fusion of semantic interpretation of data and visual optimization by a computer, rather than a mere enumeration of data. This technology maximizes information transmission efficiency in use cases such as a giant screen display system of a disaster response headquarters and a personalized disaster prevention portal for citizens.

The federated learning evolution unit has a function of continuously learning actual city operation data and new event data by federated learning to evolve a prediction and optimization model of the generative AI. For example, the AI learns past actual disaster response data, effects of traffic congestion mitigation measures, actual energy supply and demand adjustment data, effects of environmental measures, usage statuses of resident services, and the like, and highly accurate prediction and optimization become possible in city operation and disaster response from the next time onward. For example, the unit learns region-specific characteristics such as that demand for heating appliances and winter clothing increases in heavy snowfall areas in winter, delivery delays due to traffic congestion are likely to occur in urban areas, isolated settlements are likely to occur in mountainous areas, and avoidance of crowding in evacuation shelters and demand for sanitary goods increase during an infectious disease epidemic, and automatically generates an optimal plan in consideration of these in the next disaster. For example, the unit learns effects of congestion mitigation measures when past events were held, and automatically proposes optimal human flow guidance measures at the next event. Specifically, the federated learning evolution unit executes a distributed machine learning framework that achieves both privacy protection and improvement of generalization performance of a model. The federated learning evolution unit distributes an initial weight parameter of a global model to edge nodes arranged in local servers of respective local governments and infrastructure operators. Each edge node executes gradient calculation of a local model using highly confidential actual data accumulated in its own local storage. The federated learning evolution unit collects only gradient vectors calculated from the respective edge nodes via an encrypted communication channel. The federated learning evolution unit applies a secure aggregation algorithm to the collected plurality of gradient vectors, and adds noise to make individual data restoration mathematically impossible. The federated learning evolution unit updates a weight of the global model on a central server by a federated averaging method using the aggregated gradient vectors. The federated learning evolution unit evaluates performance of the updated global model using a verification data set, and deploys it to the entire system as a new model when an improvement in accuracy is confirmed. By this processing, the system exerts a technical effect of integrating knowledge of wide-area and diverse data sources without aggregating raw data in one place. This configuration realizes construction of a robust artificial intelligence model that eliminates region-specific biases while clearing constraints of data governance. This technology brings about a technical breakthrough beyond a barrier of data sharing in use cases such as joint development of a supply chain optimization model among a plurality of companies and construction of a disease prediction model in a medical institution network.

An on-site input support unit has a function of providing an interface for an on-site person in charge to input and upload an evacuation shelter status, a relief supply inventory status, a damage status, photograph and voice data, and the like from a terminal, and transmitting the input data to a server side. For example, the number and attributes of people in an evacuation shelter, types and quantities of required relief supplies, on-site photographs and videos, voice memos, detailed descriptions of damage statuses, and the like are input from a tablet terminal or a smartphone. For example, relief supply receipt confirmation and delivery completion reporting at a site are performed from a terminal. For example, an on-site person in charge quickly registers information utilizing voice input and image recognition. For example, alert notifications and instruction reception at a site are confirmed on a terminal. Specifically, the on-site input support unit implements an edge computing technology that ensures reliable data collection even under a poor communication environment or in a state of extreme fatigue of a person in charge. The on-site input support unit makes a lightweight inference model resident on a local memory of a mobile terminal. The on-site input support unit immediately executes semantic segmentation using the lightweight inference model on on-site image data photographed by a person in charge. The lightweight inference model receives, as an input, an image tensor resized to a low resolution. The lightweight inference model generates, as an output, a probability map indicating whether each pixel in an image belongs to a specific class. The on-site input support unit performs text conversion processing on voice input data using a voice recognition engine operating on an edge side, and further executes named entity extraction using a natural language processing model. The on-site input support unit combines the extracted structured data and an image analysis result, and generates a payload of a minimum size. When a network connection is unstable, the on-site input support unit queues the payload in a local non-volatile storage, and asynchronously batch-transmits the payload to a server at the moment communication is restored. By this processing, the system exerts a technical effect of preventing pressure on a communication band due to transmission of a large capacity of raw data, and distributing a processing load on a server side to an edge side. This configuration realizes advanced preprocessing and autonomous communication control on a terminal side, rather than mere provision of an input form. This technology dramatically enhances immediacy and certainty of data collection in use cases such as an information collection system for first responders at a disaster site and an inspection work system under an offline environment such as an underground facility.

An alert notification unit has a function of notifying terminals of related parties, in real time, of alerts such as important information and anomaly detection from the generative AI and the entire system, a change in a delivery plan, a rapid increase in the number of people in an evacuation shelter, a prediction of a relief supply shortage, occurrence of a road closure, an acceptance restriction of a medical institution, and occurrence of a communication failure. For example, when the number of evacuees rapidly increases at an evacuation shelter, the unit issues an alert for additional relief supply arrangement. For example, when a truck being delivered encounters a road closure, the unit issues an alert for a route change instruction. For example, when an acceptance restriction of a medical institution occurs, the unit notifies a transport instruction to a neighboring medical institution. For example, when a communication failure occurs, the unit issues an alert prompting utilization of an alternative communication means. Specifically, the alert notification unit constantly monitors an anomaly score and a prediction probability distribution output from the generative AI. The alert notification unit immediately generates a hardware interrupt when the anomaly score exceeds a preset dynamic threshold. Triggered by the interrupt, the alert notification unit executes low-latency data transmission using a push notification protocol to mobile terminals of related parties. When generating notification content, the alert notification unit dynamically generates a natural language text according to a situation using a large language model. The large language model receives, as an input, a time-series array of sensor data that triggered anomaly detection, a categorical variable indicating a type of anomaly, and a geographical coordinate vector of a target region. The large language model generates, as an output, structured data including a numerical score indicating a degree of urgency, a list of recommended response actions, and a notification text for related parties. The alert notification unit executes QoS control for preferentially allocating a bandwidth of a communication network based on the urgency score included in the structured data. By this processing, the system exerts a technical effect of reliably transmitting extremely important alert information even under a communication congestion environment such as during a disaster. The alert notification unit monitors an arrival confirmation response of a transmitted alert. When a confirmation response is not obtained within a certain period of time, the alert notification unit automatically executes retransmission processing using an alternative communication path or a different communication protocol. This configuration realizes optimization of data transmission closely linked with a communication layer, rather than mere display of information. This technology dramatically improves certainty and responsiveness of information transmission in use cases such as an emergency response system during a wide-area disaster and an anomaly monitoring system of a large-scale plant.

A generative AI prompt management unit has a function of managing prompt sentences required when utilizing the generative AI in the entire system, and providing an optimal prompt sentence to the generative AI in accordance with a situation. For example, the unit manages a prompt sentence for predicting relief supply demand for each evacuation shelter and formulating a delivery plan, a prompt sentence for a simulation instruction combining past disaster data and a current situation, a prompt sentence for an automatic response to an inquiry from an on-site person in charge, a prompt sentence for an automatic generation instruction of a disaster response manual, and the like, and provides them to the generative AI as necessary. Specific prompt sentences include “Predict a traffic congestion occurrence risk for each major intersection for the next 30 minutes based on current traffic volume data, public transportation operation statuses, and event holding information, and propose optimal traffic mitigation measures such as traffic light control and bus service increase,” “Identify an area where a supply and demand balance will be tight in the next two hours based on current energy consumption data, weather forecasts, and event information, and formulate an optimal transmission plan for distributed power generation and power saving alerts,” and “Formulate an area with a high isolation risk and a preferential evacuation guidance and relief supply delivery plan based on building damage data, evacuation shelter capacity statuses, and road disruption information immediately after an earthquake occurs.” Specifically, the generative AI prompt management unit executes dynamic prompt construction processing according to a situation context. The generative AI prompt management unit holds a plurality of prompt templates as vector representations in a database. The generative AI prompt management unit generates a multidimensional state vector indicating a current system state. The multidimensional state vector includes elements obtained by digitizing a type of disaster, an elapsed time, a damage scale, and a type of available data source. The generative AI prompt management unit calculates a cosine similarity between the multidimensional state vector and the vector representation of the prompt template. The generative AI prompt management unit selects a template with the highest similarity. The generative AI prompt management unit automatically embeds real-time sensor data and a database search result into a placeholder of the selected template. During embedding processing, the generative AI prompt management unit applies an importance-based text summarization algorithm so that the number of tokens of input data does not exceed a context window limit of the large language model. The generative AI prompt management unit inputs the constructed prompt to an inference engine of the large language model. The inference engine outputs a text stream including a prediction result and a draft plan based on the input prompt. The generative AI prompt management unit parses the output text stream and converts it into structured data processable by a subsequent system module. By this processing, the system realizes fully automated prompt optimization based on mechanical state determination, unlike a conventional method in which a human manually inputs a prompt. This configuration exerts a technical effect of improving inference accuracy of the large language model and preventing waste of calculation resources due to an invalid prompt. This technology is applicable to an autonomous control system of a smart city, a dynamic optimization system of a complex supply chain, and the like.

As described above, the system according to the present embodiment collects and integrates diverse data in a city in real time, generates a highly accurate digital twin on a whole city and each area basis, realizes optimization of city operation and automatic response in the event of a disaster with generative AI as an essential component, visualizes and shares information, and evolves a model by federated learning, thereby becoming a unique social infrastructure that realizes sustainable optimization and resilience improvement of the whole city.

### Implementation Steps

Step 1: Real-time Collection and Integration of City Data

All data related to city activities, such as acquiring the number of vehicles, average speed, and traffic volume by vehicle type from traffic volume sensors installed on major arterial roads and intersections in a city, acquiring operation statuses and delay information of buses, railways, subways, and streetcars from operation management systems of public transportation, acquiring switching timings and failure information of traffic lights from a traffic light control system, acquiring availability and utilization rates from a parking lot management system, acquiring power, gas, and water consumption of each home, building, and factory and operation statuses of solar power generation and storage batteries from an energy management system, acquiring temperature, humidity, precipitation, wind speed, and solar radiation from a meteorological observation system, acquiring air quality (PM2.5, NOx, CO2), noise, and vibration from environmental sensors, acquiring positions and collection statuses of garbage collection vehicles, acquiring movement histories from residents' smartphones and transportation IC cards, and acquiring resident service usage histories, administrative procedure histories, event holding information, disaster occurrence information, infrastructure operation statuses, disaster/congestion/infrastructure anomaly report data from SNS and reporting applications, operation statuses of IoT home appliances, operation statuses of medical institutions, attendance information and school safety information of educational institutions, operation statuses of logistics bases, and location information of delivery vehicles, are aggregated to a server by various means such as API linkage, IoT sensors, existing business system linkage, terminal input by an on-site person in charge, image recognition and voice recognition, and image analysis of drones and surveillance cameras, and are integrated after being subjected to encryption and anonymization processing. Specifically, in this step, the system ingests a huge data stream asynchronously transmitted from a group of distributed edge devices at high speed using an in-memory data grid. The system analyzes header information of each received data packet, and extracts a data type, a transmission source ID, and a time stamp. The system dynamically routes data to an appropriate processing pipeline based on the extracted metadata. The system applies an abnormal value detection algorithm to time-series numerical data, and filters spike noise caused by a sensor failure or a communication error in real time. The system executes a convolutional neural network on a parallel computing cluster for image and video data, and extracts objects such as vehicles, pedestrians, and obstacles as bounding boxes. The system coordinate-transforms coordinate information of the extracted objects into a common geospatial coordinate system. The system registers the heterogeneous data for which these preprocessings have been completed as nodes and edges of a graph database, and constructs semantic relevance between data as links. By this processing, the system exerts a technical effect of continuously generating a high-quality and structured data set that can be immediately calculated by a subsequent artificial intelligence model. This configuration automates semantic integration and quality assurance of data, rather than mere accumulation of data. This technology reduces latency of data processing to the utmost limit in use cases such as a wide-area control system for autonomous vehicles and a real-time supply and demand adjustment system of a smart grid.
Step 2: Generation and Update of City Digital Twin

Using a wide variety of data obtained from the city data collection and integration unit, buildings, roads, traffic, energy infrastructure, environment, resident activities, infrastructure operation statuses, logistics bases, medical institutions, educational institutions, event venues, and the like are reproduced in a virtual space with high accuracy on a whole city and each area basis, and a state of the city is updated in real time. For example, map data acquired from a geographic information system, 3D models of buildings, road networks, topographical data of rivers and mountains, location information of evacuation shelters, medical institutions, and logistics bases, population distribution data, operation statuses of critical infrastructure, and the like are integrated to faithfully reproduce a real-world city structure and activities. When a disaster occurs, an influence range of an earthquake, flood, landslide disaster, tsunami, fire, power outage, large-scale communication failure, or the like is simulated, and damage assumptions, impassable sections, isolated regions, the capacity of evacuation shelters, the number of acceptable patients of medical institutions, operation statuses of logistics bases, and the like are immediately reflected on the digital twin. Specifically, in this step, the system dynamically reconstructs a voxel grid in a three-dimensional space based on information of the integrated graph database. The system allocates a multidimensional vector indicating a physical attribute, a thermodynamic attribute, and an electromagnetic attribute to each voxel. Every time real-time sensor data is updated, the system overwrites and updates a voxel vector of corresponding spatial coordinates. When receiving a trigger signal of disaster occurrence, the system activates a structural analysis simulator using a finite element method. The simulator inputs acceleration data of seismic waves and inundation depth data as boundary conditions, and calculates a stress distribution of a building and a destruction probability of infrastructure. The system changes a status of an object whose calculated destruction probability exceeds a predetermined threshold to function stop, and logically disconnects an edge connected to a corresponding node on the graph database. The system propagates this topology change to the entire network, and identifies an influence range of a cascading failure. By this processing, the system exerts a technical effect of synchronizing a physical change in the real world to the virtual space with a delay in milliseconds. This configuration strictly simulates a dynamic state transition based on physical laws on a computer, not limited to display of a static 3D model. This technology provides a prediction environment extremely close to reality in use cases such as digital twin construction of a large-scale plant and a city-level disaster prevention drill simulator.
Step 3: City operation optimization and disaster response simulation by generative AI. The generative AI is used as an essential component to analyze data on a city digital twin, and realize optimization of city operation and automatic response in the event of a disaster. For example, in a traffic field, traffic volume data, public transportation operation statuses, traffic light states, parking lot availability, resident movement histories, event holding information, and the like are analyzed, a future traffic congestion occurrence risk is predicted, and optimization of traffic light control, increase in public transportation services, proposal of detour routes, automatic issuance of traffic regulations, and the like are simulated, proposed, and executed in real time. In an energy field, consumption data and meteorological data are analyzed, and power saving alerts and instructions to utilize distributed power generation are automatically transmitted to optimize a power supply and demand balance during peak hours. In an environmental field, air quality and noise data are analyzed, and measures such as traffic regulations, promotion of greening, and optimization of garbage collection routes are automatically proposed and executed. In disaster response, damage expansion prediction, evacuation guidance, infrastructure restoration prioritization, a relief supply delivery plan, and the like are automatically formulated and executed. Specific examples of prompt sentences to be read by the generative AI include “Predict a traffic congestion occurrence risk for each major intersection for the next 30 minutes based on current traffic volume data, public transportation operation statuses, and event holding information, and propose optimal traffic mitigation measures such as traffic light control and bus service increase,” “Identify an area where a supply and demand balance will be tight in the next two hours based on current energy consumption data, weather forecasts, and event information, and formulate an optimal transmission plan for distributed power generation and power saving alerts,” and “Formulate an area with a high isolation risk and a priority evacuation guidance and relief supply delivery plan based on building damage data, evacuation shelter capacity statuses, and road disconnection information immediately after an earthquake occurs.” Specifically, in this step, the system inputs a current state vector of the digital twin to a hybrid architecture of a large language model and a deep reinforcement learning model. The system first uses the deep reinforcement learning model to search for a candidate group of optimal control parameters from a vast action space at high speed. The deep reinforcement learning model receives a congestion degree matrix of a traffic network and a load vector of a power grid as inputs. The deep reinforcement learning model generates a continuous value vector indicating the number of seconds of green time extension of a traffic light and a discharge amount of a storage battery as an output. The system converts the generated candidate group of control parameters into a natural language prompt and inputs the prompt to the large language model. The large language model collates the input prompt with a past similar case database, and logically infers social impacts and secondary risks brought about by each candidate. The large language model generates structured data including an evaluation score for each candidate, an explanation of risk factors, and a finally recommended action plan as an output. The system automatically selects an action plan having the highest evaluation score, and transmits a control command to a control device of corresponding infrastructure. By this processing, the system exerts a technical effect of realizing advanced decision-making that fuses mathematical optimization and human common sense reasoning. This configuration imparts explainability to a judgment process of AI that is likely to be a black box, and enables safe and reliable automatic control. This technology dramatically improves operation efficiency in use cases such as an integrated control center of a smart city and a dynamic routing system of a wide-area logistics network.
Step 4: Information sharing and visualization. A state of the city, predictions, optimization proposals, response plans in the event of a disaster, and the like are visualized and shared in real time with related parties such as city operators, infrastructure operators, and residents via a dashboard or a notification. For example, traffic conditions of the whole city, energy supply and demand, environmental indicators, damage statuses and evacuation shelter capacity statuses when a disaster occurs, infrastructure restoration progress, and the like are visualized on a map or a graph so that related parties can immediately grasp a situation. For residents, optimal movement routes, power saving alerts, and evacuation instructions in the event of a disaster are notified by a smartphone application, and for city operators, risks and optimization proposals of the whole city are displayed in a list on a dashboard. Specifically, in this step, the system dynamically converts a format of the generated optimization plan and prediction data according to terminal characteristics of a user and a network bandwidth. For a high-resolution display of a city operator, the system executes three-dimensional particle rendering to visually express microscopic changes in traffic flow and energy flow. For a smartphone of a resident, the system utilizes a geofencing technology based on coordinates to filter and transmit only related information within a radius of several kilometers from a current position of the user. In order to minimize a transmission data amount, the system distributes map data in a vector tile format and causes a terminal side to execute rendering processing. The system automatically generates a natural language summary text explaining a tendency of a complex data chart using a large language model, and presents the summary text together with visual information. By this processing, the system exerts a technical effect of presenting data optimized for a context of an information recipient and reducing a cognitive load. This configuration realizes not merely screen display but distributed rendering and adaptive data distribution utilizing computing resources of a client terminal. This technology improves the degree of understanding of information and the promptness of action in use cases such as a personalized disaster prevention application for citizens and an augmented reality navigation system for field workers.
Step 5: Model evolution by federated learning. Actual city operation data and new event data are continuously learned by federated learning to evolve a prediction and optimization model of the generative AI. For example, the AI learns past actual disaster response data, effects of traffic congestion mitigation measures, actual energy supply and demand adjustment data, effects of environmental measures, usage statuses of resident services, and the like, enabling highly accurate prediction and optimization in subsequent city operations and disaster responses. The AI learns region-specific characteristics, such as an increase in demand for heating appliances and winter clothing in heavy snowfall areas in winter, a tendency for delivery delays due to traffic congestion to occur in urban areas, a tendency for isolated settlements to occur in mountainous areas, and an increase in demand for avoiding crowding in evacuation shelters and sanitary goods during an infectious disease epidemic, and automatically generates an optimal plan considering these characteristics in the next disaster. Specific examples of prompt sentences to be read by the generative AI include “Integrate past actual disaster response data and new event data to update a relief supply demand prediction model for the next disaster” and “Generate a disaster response simulation model reflecting region-specific characteristics and past lessons.” Specifically, in this step, the system executes a federated learning protocol using an edge node group distributed and arranged in a local server of each region. The system broadcasts a weight matrix of the latest global model from a central server to each edge node. Each edge node executes retraining of a local model using unique environmental data and resident movement histories collected within its own jurisdiction area. In this retraining process, each edge node calculates an error between a predicted value and an actual result as a loss function, and calculates an update vector of weights by a stochastic gradient descent method. The system receives the update vector transmitted from each edge node at the central server, and integrates the update vectors using a secure aggregation algorithm. The system updates parameters of the global model using the integrated update vector to improve generalization performance of the model. The system evaluates the updated model with a test dataset, and automatically executes deployment to a production environment only when an accuracy index exceeds a prior reference value. By this processing, the system exerts a technical effect of continuously evolving intelligence of the entire system without aggregating highly confidential personal information and detailed infrastructure data in one place. This configuration mathematically solves a trade-off between protection of data privacy and improvement of performance of a machine learning model. This technology realizes safe and efficient model operation in use cases such as a wide-area cooperative disaster prevention system among a plurality of local governments and distributed supply chain optimization of a global company.

### Specific Use Case

For example, assume a case where a large-scale sports event is held in a city center. In this case, the city data collection and integration unit acquires, in real time, the number of vehicles, an average speed, and a traffic volume by vehicle type from traffic volume sensors installed on major arterial roads and intersections, and simultaneously collects operation statuses and delay information of buses and railways from an operation management system of public transportation, switching timings and failure information of traffic lights from a traffic light control system, availability and utilization rates from a parking lot management system, inflow and outflow data of visitors from person movement sensors around an event venue, congestion and traffic obstacle report data from SNS and reporting applications, and the like. Furthermore, temperature, humidity, precipitation, and wind speed from a meteorological observation system, air quality and noise data from environmental sensors, positions of garbage trucks and full sensor information of garbage cans, movement histories from smartphones and transportation IC cards of residents, delivery vehicle position information of logistics bases, and the like are also integrated, and the city digital twin generation and update unit reproduces a virtual space model of the whole city and the periphery of the event venue with high accuracy based on these data, and visualizes traffic, person movement, environment, and infrastructure operation statuses in real time. Specifically, the system executes adaptive sensing control that dynamically raises a sampling rate of data collection in order to respond to a specific context of holding an event. The system multicasts a control command for setting a data transmission frequency to several times a normal frequency to a sensor group within a specific radius centered on the event venue. In order to process rapidly increasing data traffic, the system activates a stream processing engine on an edge computing node, and distributedly executes primary processing such as calculation of a moving average and noise removal. In order to estimate a crowd density from a camera image, the system applies a convolutional neural network specialized for crowd counting. The neural network receives an image tensor of a crowd as an input, and generates a density map indicating a probability that each pixel is a human head as an output. The system calculates an accurate number of staying people in a specific area by spatially integrating the density map. The system generates a vector field of person movement by combining the calculated number of people data and ticket gate passage history data of transportation IC cards on a time axis. The system maps these high-resolution data to a voxel space of the digital twin, and constructs a state capable of simulating an interaction between microscopic crowd movement and macroscopic traffic flow. By this processing, the system exerts a technical effect of accurately capturing a non-linear change in a city state due to a sudden event without delay. This configuration autonomously optimizes an observation network following a change in a situation without depending on a static data collection schedule. This technology realizes prevention of crowd accidents and smooth guidance in use cases such as a security support system for a large-scale festival and a dynamic traffic control system around a stadium.

The city operation optimization unit uses the generative AI as an essential component, analyzes traffic volume data, public transportation operation statuses, traffic light states, parking lot availability, event holding information, person movement sensor data, SNS report data, and the like, and predicts a future traffic congestion occurrence risk and a crowding risk. For example, when traffic congestion or person movement concentration is predicted around major intersections or stations in a time zone before and after the start of an event, the generative AI simulates, proposes, and executes, in real time, automatic optimization of traffic light control, temporary increase in bus and railway services, recommendation of park-and-ride, notification of optimal movement routes to residents and visitors, automatic issuance of traffic regulations, and the like. Also, based on full sensor information of garbage cans around the event venue and position information of garbage trucks, the generative AI automatically generates an optimal garbage collection route to maximize cleaning efficiency after the event ends. Furthermore, when a heatstroke risk or an air pollution risk increases based on temperature and air quality data, the generative AI automatically notifies event organizers and residents of alerts and proposed measures. Specifically, the city operation optimization unit inputs the collected high-resolution person movement vector field and traffic flow data to a spatiotemporal prediction model combining a graph neural network and a transformer. The spatiotemporal prediction model receives, as an input, a multidimensional time-series tensor including the number of passing people, the number of vehicles, and meteorological conditions at each intersection and pedestrian passage for the past several hours. The spatiotemporal prediction model outputs, as an output, a predicted transition of a congestion degree score of each node in the next several hours. The city operation optimization unit identifies a node where the predicted congestion degree score exceeds a safety threshold, and calculates a control action for restricting inflow to the node. The city operation optimization unit dynamically calculates optimal values of a cycle length, a split, and an offset of a traffic light using a reinforcement learning algorithm. The city operation optimization unit inputs the calculated control parameters to a large language model, and causes the large language model to automatically generate a detour route guidance text for event visitors. The large language model receives, as an input, a current congestion status, a coordinate list of recommended detour routes, and schedule information of the event. The large language model generates, as an output, a guidance message using plain expressions to avoid confusion among visitors. The city operation optimization unit push-distributes the generated message to digital signage or a dedicated smartphone application. By this processing, the system exerts a technical effect of preemptively distributing traffic before local congestion develops into traffic paralysis of the whole city. This configuration realizes proactive crowd control based on highly accurate future prediction, rather than a reactive response. This technology dramatically improves safety and convenience of participants in use cases such as mobility management of the whole city in a mega event such as an international sports tournament and logistics optimization of a large-scale exhibition.

From a viewpoint of disaster response, when a sudden heavy rain or earthquake occurs during an event, the city data collection and integration unit immediately collects breaking news from a meteorological observation system and seismometers, evacuation shelter capacity statuses, road flooding sensors, building damage information, report data from SNS, and the like, and the city digital twin generation and update unit immediately reflects a damage range, congestion statuses of evacuation shelters, impassable sections, isolation risk areas, and the like in a virtual space. The city operation optimization unit automatically formulates and executes damage expansion prediction, an evacuation guidance plan, infrastructure restoration prioritization, a relief supply delivery plan, and the like using the generative AI, and notifies residents and event visitors of optimal evacuation instructions and safety information in real time. Specifically, the system executes processing in a distributed computing environment composed of a plurality of computing nodes. The city data collection and integration unit converts raw data acquired from various sensors into a multidimensional time-series tensor. The city digital twin generation and update unit maps the converted tensor data to 3D spatial coordinates. The processing unit models spatial dependencies of city infrastructure using a graph neural network. The city operation optimization unit adopts a composite AI architecture combining a large language model and a reinforcement learning agent. Input data to the AI are a time-series array of meteorological data, graph structure data indicating infrastructure damage statuses, and an embedding vector of SNS text. Specific examples of the input data include a time-series tensor of precipitation of 50 millimeters per hour, a disconnection flag of a specific road node, and a capacity rate numerical value of an evacuation shelter node. The AI arithmetically processes these input data in a high-dimensional space. Output data from the AI are an impassability probability score of each road link, a congestion prediction probability distribution of each evacuation shelter, and a ranking list of restoration priorities. Specific examples of the output data include an impassability probability of 0.85 for road A, a capacity rate prediction of 95 percent for evacuation shelter B, and a restoration priority score of 0.92. The system passes an output result to subsequent processing. The subsequent processing unit executes branching processing of excluding the route from calculation targets of an evacuation route when the output score exceeds a preset threshold. Unlike conventional rule-based judgment by humans, the system autonomously constructs a non-linear damage propagation model. The system analyzes a wide-area damage status at a speed impossible for humans by parallel computation in a high-dimensional space. By this processing, the system exerts a technical effect of dramatically improving calculation efficiency and prediction accuracy of evacuation guidance. Specific application fields of the system are assumed to be dynamic evacuation guidance and optimal arrangement of rescue units during a guerrilla rainstorm while a large-scale outdoor festival is held.

The information sharing and visualization unit visualizes and shares, in real time, a state of the city, traffic, person movement, environment, disaster risks, infrastructure restoration progress, and the like with city operators, infrastructure operators, event organizers, residents, security and emergency personnel, and the like via a dashboard or a notification. For example, on a dashboard for city operators, congestion degrees around major intersections and stations, operation statuses of public transportation, garbage collection progress, damage statuses and evacuation shelter capacity statuses when a disaster occurs, infrastructure restoration progress, and the like are displayed on a map or a graph so that related parties can immediately grasp a situation and make a decision. Residents and visitors are automatically notified of optimal movement routes, congestion avoidance routes, power saving alerts, evacuation instructions in the event of a disaster, and the like by a smartphone application. Specifically, the information sharing and visualization unit executes rendering processing by parallel computation using an image processing processor. The processing unit dynamically optimizes display contents for each user using a neural network equipped with an attention mechanism. Input data to the AI are a profile vector indicating user attributes and a multidimensional tensor indicating a city state. Specific examples of the input data include a user vector having an administrator authority flag, and numerical data such as a congestion degree score of 0.9 at a specific intersection and an infrastructure restoration progress rate of 0.5. The AI extracts feature amounts of the input data and determines importance. Output data from the AI are structured data defining a display layout and an importance weighting score of each user interface component. Specific examples of the output data include a display flag 1 of a warning banner, a red highlight coordinate list on a map, and a generated character string of a notification text. The system passes the output structured data to subsequent processing. The subsequent processing unit calls a drawing application programming interface of a client terminal based on the structured data and asynchronously updates screen display. The system automatically executes filtering of information according to a user's situation inside a computer, rather than a mere enumeration of information. By this processing, the system exerts a technical effect of preventing a delay in drawing processing while significantly reducing a communication load on a network in the event of a disaster where a communication bandwidth is likely to be limited. Specific application fields of the system are assumed to be operation of a daily traffic management dashboard in a smart city and personalized emergency information distribution in the event of a disaster.

The federated learning evolution unit causes the AI to learn actual data of current event operation and disaster response, effects of traffic congestion mitigation measures, actual energy supply and demand adjustment data, effects of environmental measures, usage statuses of resident services, and the like, and evolves a model of the generative AI so that highly accurate prediction and optimization become possible in subsequent large-scale events and disaster responses. Specifically, the federated learning evolution unit executes federated learning between a plurality of edge devices and a central server. The system utilizes servers of respective local governments and mobile terminals of residents as edge nodes. The edge node executes learning by an error backpropagation method of a neural network using locally accumulated actual data. The edge node calculates a gradient so as to minimize a mean square error and a cross entropy error between a predicted value and an actual value. Input data during learning to the AI are a past prediction result tensor and a correct label tensor indicating an actual result. Specific examples of the input data include a predicted congestion length vector, an actual congestion length vector, and numerical data of predicted energy consumption. Output data during learning from the AI are a gradient vector indicating a weight update amount of each neural network layer. Specific examples of the output data include an update difference of a weight matrix of a first layer, an update difference of a bias term, and a fluctuation value of an attention weight. The edge node transmits only the calculated gradient vector to the central server. The central server aggregates the received plurality of gradient vectors and updates parameters of a global model. The system redistributes the updated parameters to each edge node as subsequent processing. The subsequent processing unit synchronizes a local model of each edge node with the latest global model. The system adopts a distributed processing architecture fundamentally different from a conventional method of aggregating raw data in a central server. By this processing, the system exerts a technical effect of reducing communication overhead in a distributed computing environment and improving generalization performance of a model while protecting highly confidential personal information and detailed infrastructure data. Specific application fields of the system are assumed to be sharing of disaster response know-how among a plurality of local governments and joint development of an AI model through wide-area cooperation.

Specific examples of prompt sentences to be read by the generative AI include “Predict a congestion and traffic congestion risk around major intersections and stations for the next one hour based on current traffic volume data, public transportation operation statuses, event holding information, person movement sensor data, and SNS report data, and propose optimal traffic mitigation measures such as traffic light control, public transportation service increase, park-and-ride recommendation, and congestion avoidance route notification,” “Automatically generate an optimal garbage collection route based on full sensor information of garbage cans around an event venue and position information of garbage trucks to maximize cleaning efficiency,” “Automatically notify alerts and proposed measures when a heatstroke risk or an air pollution risk increases based on data of a meteorological observation system and air quality sensor data,” and “Automatically formulate damage expansion prediction, an evacuation guidance plan, infrastructure restoration prioritization, and a relief supply delivery plan based on evacuation shelter capacity statuses, road flooding sensors, building damage information, and SNS report data when a disaster occurs, and notify residents and visitors of optimal evacuation instructions in real time.” Specifically, the system includes a prompt generation unit configured to automate prompt engineering for a natural language processing model. The prompt generation unit converts a numerical array of various sensor data collected by the system into a token sequence of natural language. The processing unit generates the converted token sequence as an embedding vector. Input data to the AI are a high-dimensional embedding vector including context information. Specific examples of the input data include a tokenized vector of traffic volume data indicating the number of vehicles of 500 per hour, a context vector including a flag value 1 of a full sensor of a garbage can, and a numerical vector of meteorological data indicating a temperature of 35 degrees. The AI analyzes dependencies between input vectors using a self-attention mechanism of a transformer architecture. Output data from the AI are a text generation result of proposed measures and a control command group structuring the text generation result. Specific examples of the output data include the number of seconds of green time extension of traffic light control plus 15 seconds, a patrol node order list of garbage trucks, and polygon coordinate data indicating a distribution target area of evacuation instructions. The system passes the output control command group to subsequent processing. The subsequent processing unit parses the control command group, converts the control command group into a communication request to each infrastructure control system, and transmits the communication request. The system integrally interprets unstructured data and structured data, and automatically generates dynamic control parameters for complex events that are difficult to handle on a rule basis. By this processing, the system exerts a technical effect of dramatically improving operation efficiency of city infrastructure and realizing autonomous optimization control without human intervention. Specific application fields of the system are assumed to be dynamic traffic regulations when a large-scale sports tournament is held and automatic infrastructure control according to environmental changes.

As described above, the system of the present invention collects and integrates various city data in real time, generates and updates a city digital twin with high accuracy, realizes optimization of city operation and automatic response in the event of a disaster with generative AI as an essential component, visualizes and shares information, and evolves a model by federated learning, thereby realizing continuous optimization and resilience improvement of the whole city. Specifically, the present system adopts a multi-agent architecture in which a plurality of different neural network models cooperate. The present system integrally executes image analysis by a convolutional neural network, time-series prediction by a recurrent neural network, and optimization control by reinforcement learning. Input data to the present AI is multimodal data of the whole city. Specific examples of the input data include an RGB image tensor acquired from a surveillance camera, a time-series numerical matrix indicating power consumption for the past year, an embedding vector of feedback text from a resident, and the like. The present AI projects these heterogeneous data into a common latent space and calculates an optimization index of the whole city. Output data from the present AI is an optimization index score of the whole city and a calculation resource allocation ratio to each subsystem. Specific examples of the output data include a city resilience score of 0.88, a calculation resource allocation of 40 percent to a traffic control module, an allocation of 60 percent to a disaster prediction module, and the like. The present system passes the output resource allocation ratio to subsequent processing. The subsequent processing unit controls a container orchestration tool on a cloud infrastructure to dynamically scale out or scale in calculation nodes. The present system dynamically redistributes calculation resources according to a change in a situation of the city. By this processing, the present system exhibits a technical effect of minimizing a processing delay in an emergency while suppressing power consumption of the entire system, and improving availability and processing efficiency of the computer system itself. As specific application fields of the present system, a seamless transition from smart city operation in normal times to an emergency response mode in the event of a large-scale disaster, complete automation of energy management of the whole city, and the like are assumed.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

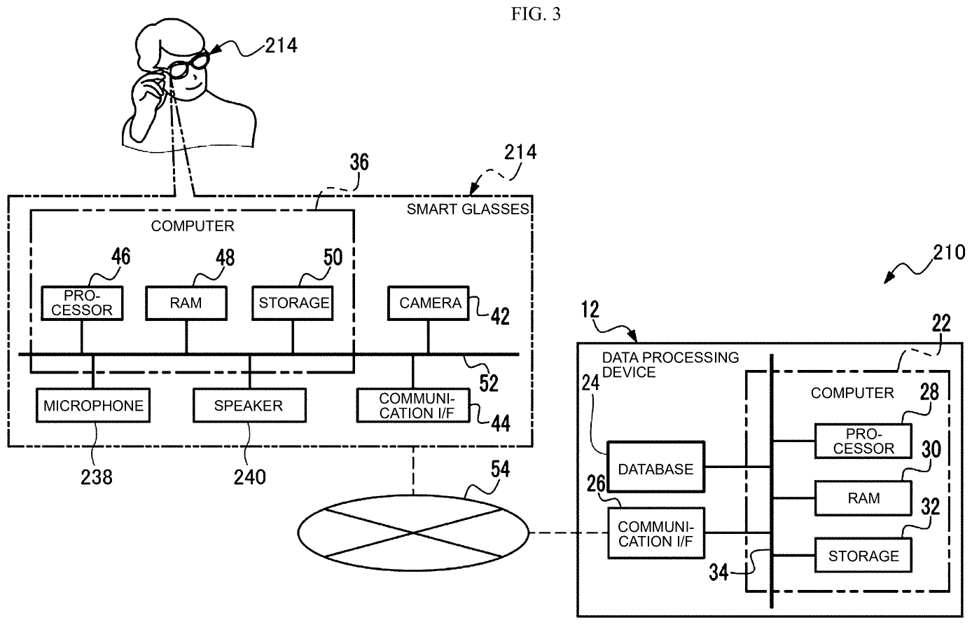

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

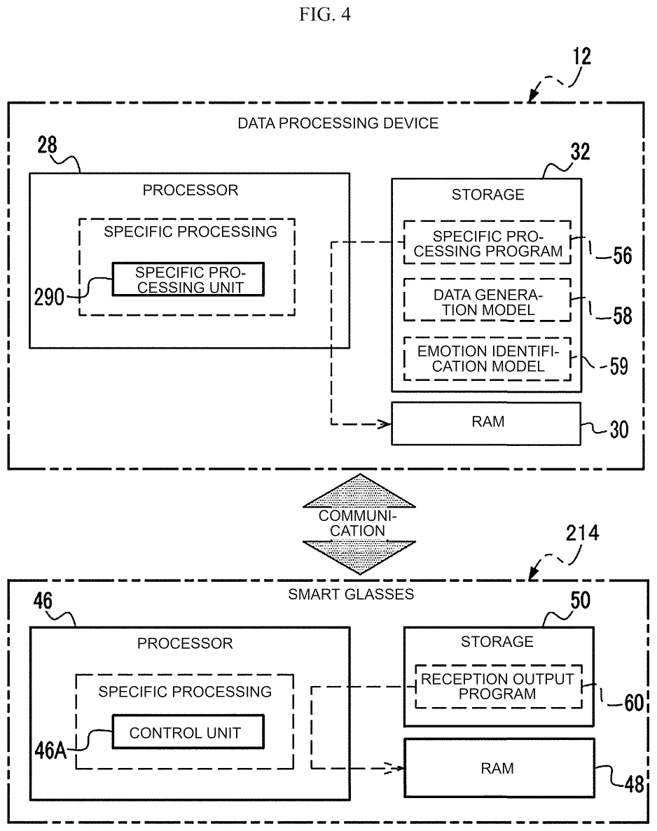

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

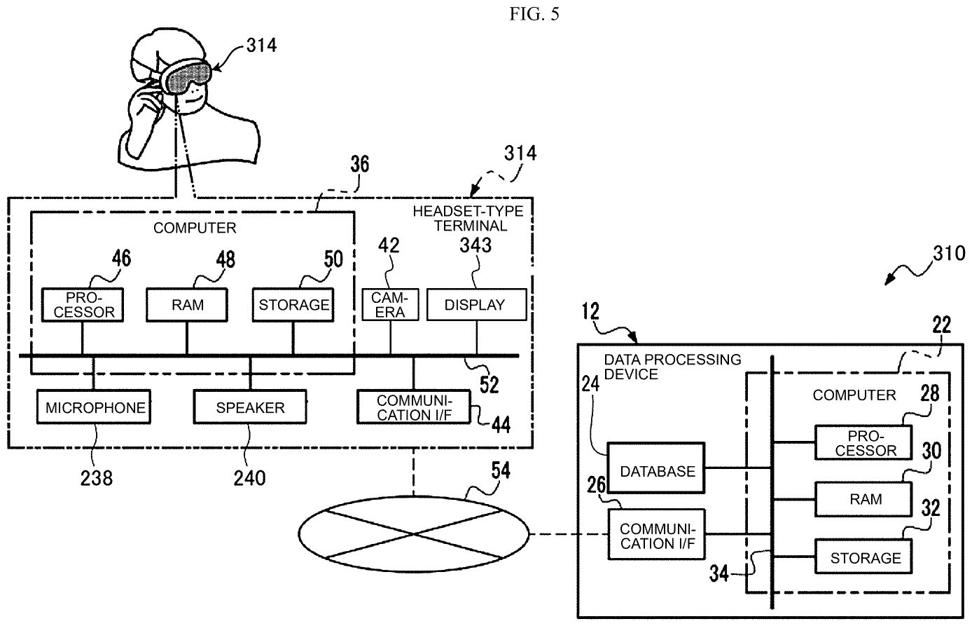

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

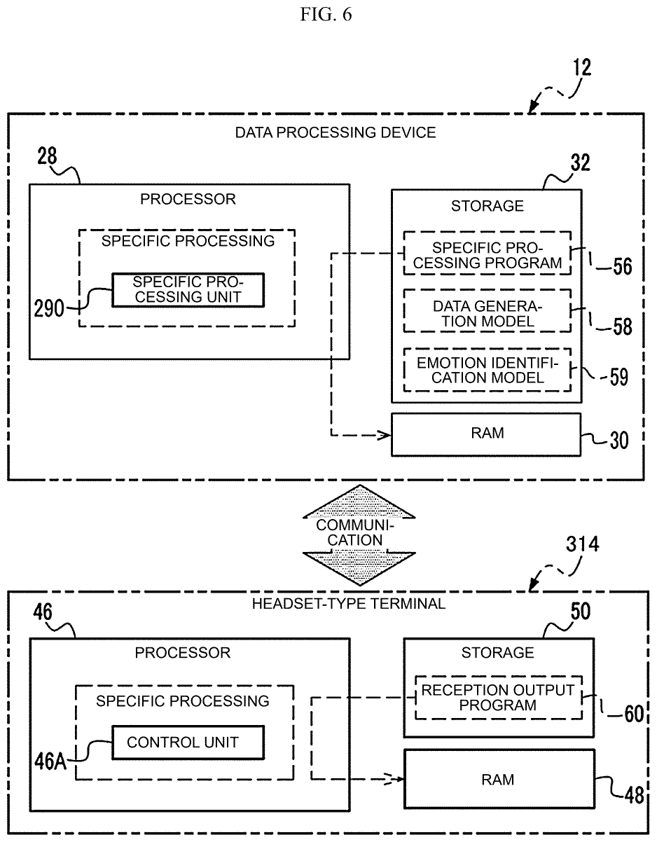

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

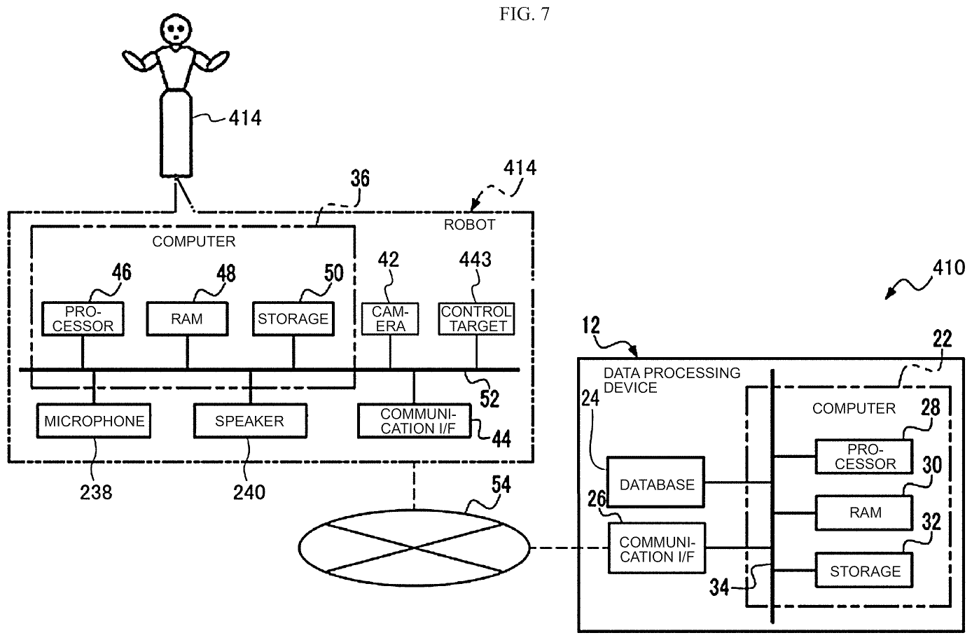

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

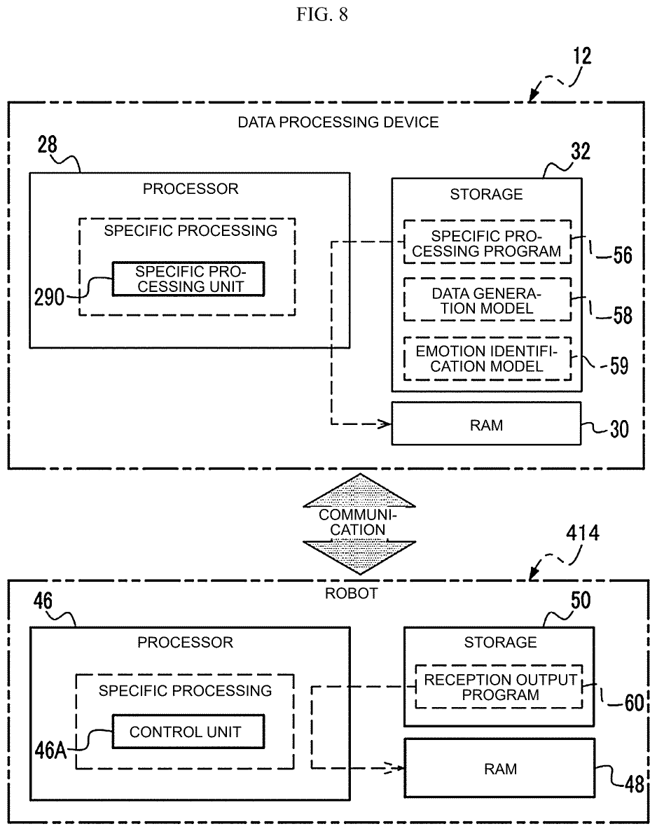

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

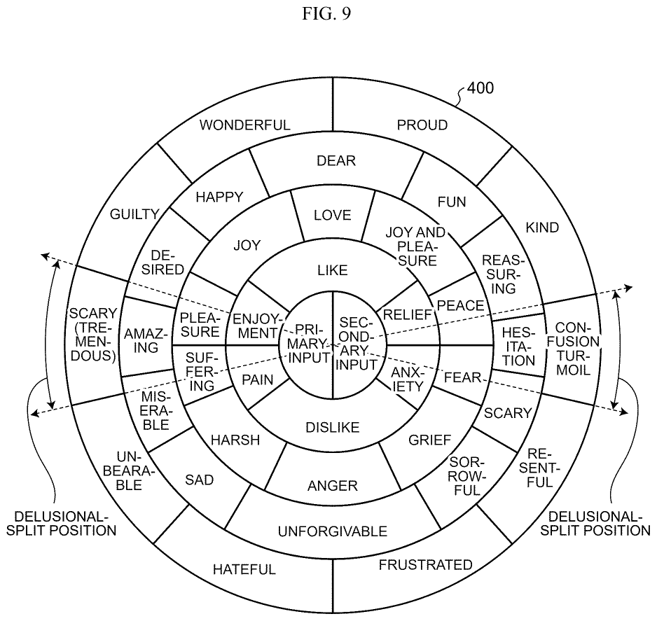

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

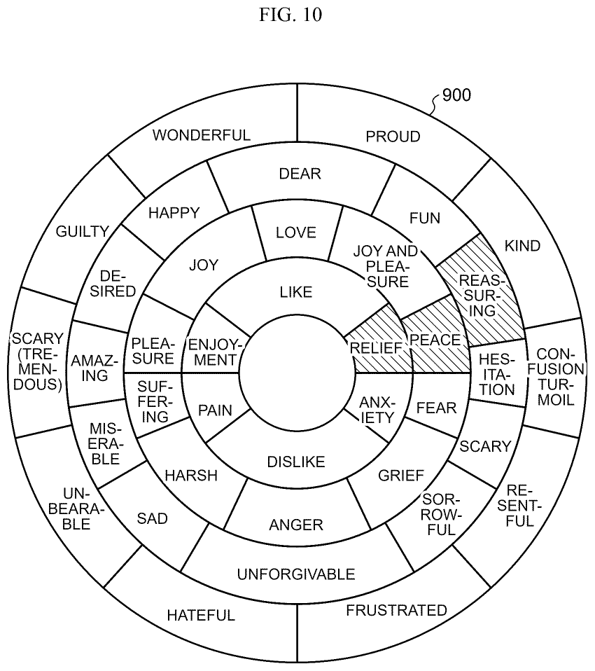

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.
(Supplementary Note 1)

A system comprising: a city data collection and integration unit configured to collect and integrate, in real time, various city data such as traffic volume sensors in a city, public transportation operation data, energy consumption data, environmental sensor data, resident movement histories, disaster occurrence information, infrastructure operation status data, resident service usage histories, event information, information from SNS and reporting applications, and operation statuses of IoT home appliances; a city digital twin generation and update unit configured to reproduce buildings, roads, traffic, energy infrastructure, environment, resident activities, and the like in a virtual space with high accuracy on a whole city and each area basis using the data obtained from the city data collection and integration unit, and update a state of the city in real time; a city operation optimization unit configured to analyze data on a city digital twin constructed by the city digital twin generation and update unit with generative AI as an essential component, and automatically simulate, propose, and execute prediction of traffic congestion and automatic proposal of mitigation measures, optimization of energy supply and demand balance, evacuation guidance and infrastructure control when a disaster occurs, proposal of measures for reducing environmental load, personalization of resident services, optimal arrangement of city events, and the like; an information sharing and visualization unit configured to visualize and share, in real time, the state of the city, predictions, optimization proposals, response plans in the event of a disaster, and the like with related parties such as city operators, infrastructure operators, and residents via a dashboard or a notification; and a federated learning evolution unit configured to continuously learn actual city operation data and new event data by federated learning to evolve a prediction and optimization model of the generative AI, wherein the city operation optimization unit operates with the generative AI as an essential component, and realizes operation optimization of the whole city and improvement of disaster response capability.
(Supplementary Note 2)

The system according to Supplementary Note 1, wherein the city operation optimization unit is configured to analyze, in a traffic field, traffic volume data, public transportation operation statuses, traffic light states, parking lot availability, resident movement histories, event holding information, and the like by the generative AI, predict a future traffic congestion occurrence risk, simulate, propose, and execute, in real time, optimization of traffic light control, increase in public transportation services, proposal of detour routes, automatic issuance of traffic regulations, and the like, and simultaneously realize facilitation of city traffic and reduction of environmental load.
(Supplementary Note 3)

The system according to Supplementary Note 1, wherein the city operation optimization unit is configured to analyze, when a disaster occurs, disaster occurrence information, evacuation shelter capacity statuses, infrastructure damage statuses, resident location information, report data from SNS and reporting applications, and the like by the generative AI, automatically formulate and execute damage expansion prediction, an evacuation guidance plan, infrastructure restoration prioritization, a relief supply delivery plan, and the like, and visualize and notify, in real time, an optimal disaster response plan to city operators and residents.

What is claimed is:

1. A system comprising:
circuitry configured to:
receive, via a communication interface coupled to a packet-switched network, a raw data stream from a plurality of IoT sensor devices distributed across a geographic region, apply noise removal and downsampling processing at an edge computing layer to generate normalized compressed feature vectors, and transmit only the compressed feature vectors to a cloud computing layer via the communication interface;
route the compressed feature vectors to specialized processing modules at the cloud computing layer, and update a digital twin model of the geographic region by mapping the compressed feature vectors to corresponding virtual state variables of infrastructure component nodes and entity state nodes in the digital twin model;
apply a generative neural network model to the digital twin model state to generate a prediction data record comprising evacuation capacity projection vectors, resource demand vectors, and infrastructure operation status predictions, and generate a response plan data record comprising resource allocation sequences and routing sequences;
apply a graph neural network to a logistics relationship graph comprising resource node identifiers and transportation network edge identifiers to compute optimal allocation and routing parameters, and update the response plan data record with the computed parameters; and
transmit the prediction data record, the response plan data record, and visualization data derived from the digital twin model state to terminal devices via the communication interface.

2. The system according to claim 1, wherein the circuitry is configured to
ingest a raw data stream generated at millisecond intervals from millions of IoT sensor devices at the edge computing layer, apply a lightweight data filtering algorithm at each edge device to remove noise and extract compact feature data, and transmit only the compact feature data to the cloud computing layer to minimize communication bandwidth consumption.

3. The system according to claim 2, wherein the circuitry is configured to
route compressed feature vectors from the edge computing layer to specialized processing modules comprising a state estimation module, a prediction module, and a resource optimization module, each operating as an independent containerized microservice on the cloud computing layer.

4. The system according to claim 1, wherein the circuitry is configured to
update the digital twin model in real time by applying a Kalman filter fusion algorithm to compressed feature vectors received from heterogeneous sensor modalities comprising numerical time-series arrays, binary event flags, and image tensor data, and maintaining a consistent virtual state representation for each infrastructure component node.

5. The system according to claim 4, wherein the circuitry is configured to
apply the graph neural network to the infrastructure component nodes and dependency edges of the digital twin model to execute message passing operations between adjacent nodes, propagate state update vectors across the graph, and generate a resource allocation matrix by applying an optimization objective function to the propagated node state vectors.

6. The system according to claim 1, wherein the circuitry is configured to
detect a disaster event signal by monitoring compressed feature vectors for anomaly patterns using an autoencoder model trained on normal operating condition data, compute a reconstruction error score for each received feature vector, and activate a disaster response processing pipeline when the reconstruction error score exceeds a disaster event threshold parameter.

7. The system according to claim 6, wherein the circuitry is configured to
immediately reflect the disaster event signal in the digital twin model by updating affected infrastructure component node state variables, apply the generative neural network model to the updated digital twin model state to generate an initial prediction data record, and transmit an emergency alert data record to terminal devices associated with administrative user identifiers via the communication interface.

8. The system according to claim 1, wherein the circuitry is configured to
compute the evacuation capacity projection vectors by applying the generative neural network model to population density data, current shelter occupancy records, and transportation network state data from the digital twin model, and generate a resource demand forecast by projecting required resource quantities over a configurable time horizon.

9. The system according to claim 8, wherein the circuitry is configured to
generate the resource allocation sequences in the response plan data record by applying the graph neural network to a resource supply-demand graph comprising supply node identifiers, demand node identifiers, and transportation capacity edge weights, and computing minimum-cost flow paths from supply nodes to demand nodes.

10. The system according to claim 1, wherein the circuitry is configured to
apply a scenario simulation process by modifying specified infrastructure component node state variables in the digital twin model according to hypothetical scenario parameter sets, re-applying the generative neural network model to the modified digital twin model state, and generating comparative scenario outcome data records for transmission to terminal devices.

11. The system according to claim 1, wherein the circuitry is configured to
share the prediction data record, the response plan data record, and the digital twin model state data with authorized external terminal devices via the communication interface using a role-based data access control policy, and maintain a real-time update channel transmitting differential state updates to subscribed terminal devices.

12. The system according to claim 1, wherein the circuitry is configured to
generate visualization data from the digital twin model state by computing spatial density heat maps, infrastructure status overlays, and resource flow diagrams, and transmit the visualization data to terminal devices as a structured data object for rendering in a map-based user interface.

13. The system according to claim 1, wherein the circuitry is configured to
update the digital twin model and the generative neural network model by generating training pairs from historical disaster event records and corresponding validated response plan outcome records, and fine-tune the models on the training pairs to improve prediction accuracy for specific geographic and event type patterns.

14. The system according to claim 1, wherein the circuitry is configured to
receive natural language query data from a terminal device via the communication interface, apply a natural language processing model to generate a query embedding vector, retrieve relevant prediction records and response plan records from a vector database by cosine similarity search, and generate a natural language answer using the generative neural network model.

15. The system according to claim 1, wherein the circuitry is configured to
record all digital twin model state updates, prediction data records, response plan data records, and terminal device acknowledgment records in an audit log data structure with timestamps for post-event analysis.

16. The system according to claim 1, wherein the circuitry is configured to
encrypt data transmissions between edge computing layer devices and cloud computing layer nodes using a transport layer security protocol, and authenticate each edge device using a device certificate prior to accepting compressed feature vectors for routing.

17. The system according to claim 1, wherein the IoT sensor devices are distributed across a geographic region comprising infrastructure monitoring points, the digital twin model represents the geographic region as a graph of infrastructure component nodes and entity state nodes, and the response plan data record specifies resource allocation and routing parameters for operational response to detected events.

18. A system comprising:
circuitry configured to:
receive, via a communication interface coupled to a packet-switched network, a raw data stream from IoT sensor devices, apply noise removal and downsampling at an edge computing layer to generate compressed feature vectors, and route the compressed feature vectors to specialized processing modules at a cloud computing layer;
update a digital twin model by mapping compressed feature vectors to virtual state variables of infrastructure component nodes, and apply a graph neural network to execute message passing operations to generate a resource allocation matrix;
detect event signals using an autoencoder anomaly detection model and activate a response pipeline, applying a generative neural network model to the updated digital twin model to generate prediction and response plan data records;
generate scenario simulation outputs by modifying infrastructure node state variables and comparing scenario outcomes; and
transmit prediction data records, response plan data records, and visualization data to terminal devices via the communication interface.

19. The system according to claim 18, wherein the circuitry is configured to
generate resource allocation sequences by applying a minimum-cost flow algorithm to a supply-demand graph, share digital twin model state data via a role-based access control policy with real-time differential update channels, and generate training pairs from historical event records to fine-tune the generative neural network model and the digital twin model.

20. A method comprising:
receiving, via a communication interface coupled to a packet-switched network, a raw data stream from IoT sensor devices distributed across a geographic region, applying noise removal and downsampling at an edge computing layer to generate compressed feature vectors, and transmitting the compressed feature vectors to a cloud computing layer;
routing the compressed feature vectors to specialized processing modules at the cloud computing layer, and updating a digital twin model by mapping the compressed feature vectors to virtual state variables of infrastructure component nodes;
applying a generative neural network model to the digital twin model state to generate a prediction data record and a response plan data record comprising resource allocation sequences and routing sequences;
applying a graph neural network to a logistics relationship graph to compute optimal allocation and routing parameters; and
transmitting the prediction data record, the response plan data record, and visualization data to terminal devices via the communication interface.
